(19) United States
(12) Patent Application Publication
(10) Pub. No.: US 2011/0145074 A1
(43) Pub. Date: Jun. 16, 2011

(54) APPARATUSES, METHODS AND SYSTEMS FOR AN ENVIRONMENTAL ADVERTISING, FINANCING AND MANAGEMENT PLATFORM

(76) Inventor: Paul Anthony Polizzotto, Rancho Palos Verdes, CA (US)

(21) Appl. No.: 12/973,760

(22) Filed: Dec. 20, 2010

Related U.S. Application Data
(60) Provisional application No. 61/378,915, filed on Aug. 31, 2010.

(51) Int. Cl. G06Q 30/00; G06Q 40/00

(52) U.S. Cl. 705/14.66; 705/39

(57) ABSTRACT

An advertising, financing and management platform (“ECO AD PLATFORM”) transforms pollution offset inputs via ECO AD PLATFORM components into carbon credit outputs. A pollution offset request may be obtained from a consumer for a specified environment-impacting activity. Environment-impacting activity parameters associated with the environment-impacting activity may be discerned. An environment impact purchase offset amount may be calculated using the discerned environment-impacting activity parameters. The calculated environment impact purchase offset amount may be provided to an offset paying target, and an offset payment may be obtained from the offset paying target.

### RELATED APPLICATIONS

Applicant hereby claims priority under 35 USC §119 for U.S. provisional patent application Ser. No. 61/378,915 filed Aug. 31, 2010, entitled “APPARATUSES, METHODS AND SYSTEMS FOR AN ENVIRONMENTAL ADVERTISING, FINANCING AND MANAGEMENT PLATFORM,” attorney docket no. 20781-002PV1.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property apparatus have no objection to the facsimile reproduction of the patent disclosure document by anyone as it appears in published Patent Office file/records, but otherwise reserve all rights.

The entire contents of the aforementioned applications are herein expressly incorporated by reference in their entirety.

### FIELD

The present innovations are directed generally to funding environmental projects, and more particularly, to APPARATUSES, METHODS AND SYSTEMS FOR AN ENVIRONMENTAL ADVERTISING, FINANCING AND MANAGEMENT PLATFORM.

### BACKGROUND

Environmental organizations, such as Green Peace, Earth System Governance Project, etc., strive to find ways to improve the environment. The US Environmental Protection Agency (EPA) has been established to protect the environment, and the EPA develops and enforces regulations regarding acceptable environmental conditions and creates initiatives and provides grants to help achieve those conditions.

Advertisers may place ads through advertising networks including broadcast radio/television and more recently, via the Internet. The costs to run advertising vary depending on the complexity of production, the outlet used, and the timing and frequency of placement.

### BRIEF DESCRIPTION OF THE DRAWINGS

The accompanying appendices and/or drawings illustrate various non-limiting, example, innovative aspects in accordance with the present descriptions:

FIG. 1 shows an exemplary usage scenario in one embodiment of the ECO AD PLATFORM;

FIG. 2 shows a screen shot diagram illustrating an EcoAd kiosk in one embodiment of the ECO AD PLATFORM;

FIG. 3 shows a screen shot diagram illustrating an EcoAd application in one embodiment of the ECO AD PLATFORM;

FIG. 4 shows a screen shot diagram illustrating an EcoAd barcode application in one embodiment of the ECO AD PLATFORM;

FIG. 5 shows a data flow diagram in one embodiment of the ECO AD PLATFORM;

FIG. 6 shows a logic flow diagram illustrating offsetting a consumer's carbon impact in one embodiment of the ECO AD PLATFORM;

FIG. 7 shows a logic flow diagram illustrating a kiosk carbon usage tracking (KCUT) component in one embodiment of the ECO AD PLATFORM;

FIG. 8 shows a logic flow diagram illustrating an application carbon usage tracking (ACUT) component in one embodiment of the ECO AD PLATFORM;

FIG. 9 shows a logic flow diagram illustrating a purchase offset calculating (POC) component in one embodiment of the ECO AD PLATFORM;

FIG. 10 shows a logic flow diagram illustrating an advertisement retrieving (AR) component in one embodiment of the ECO AD PLATFORM;

FIG. 11 shows a logic flow diagram illustrating a transaction benefit apportionment (TBA) component in one embodiment of the ECO AD PLATFORM;

FIG. 12 shows a screen shot diagram illustrating an Eco Project Application in one embodiment of the ECO AD PLATFORM;

FIG. 13 shows a logic flow diagram illustrating a project application approving (PAA) component in one embodiment of the ECO AD PLATFORM; and

FIG. 14 shows a block diagram illustrating embodiments of an ECO AD PLATFORM controller.

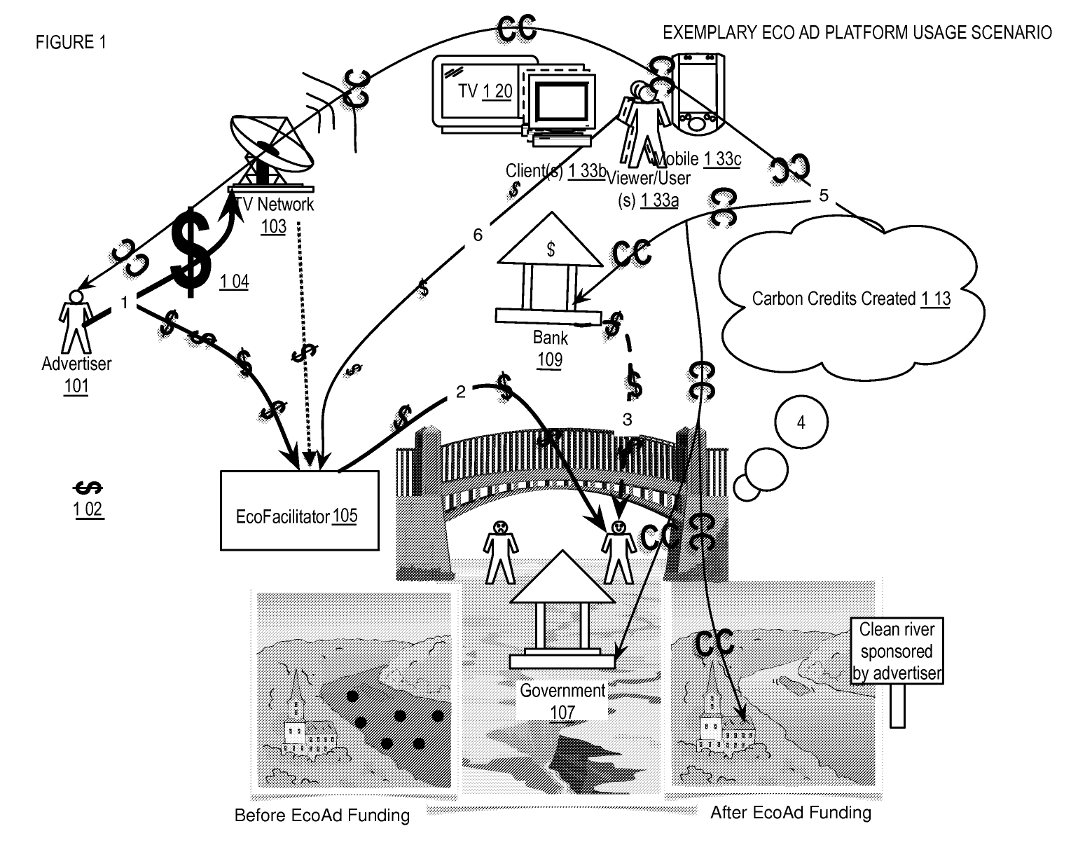

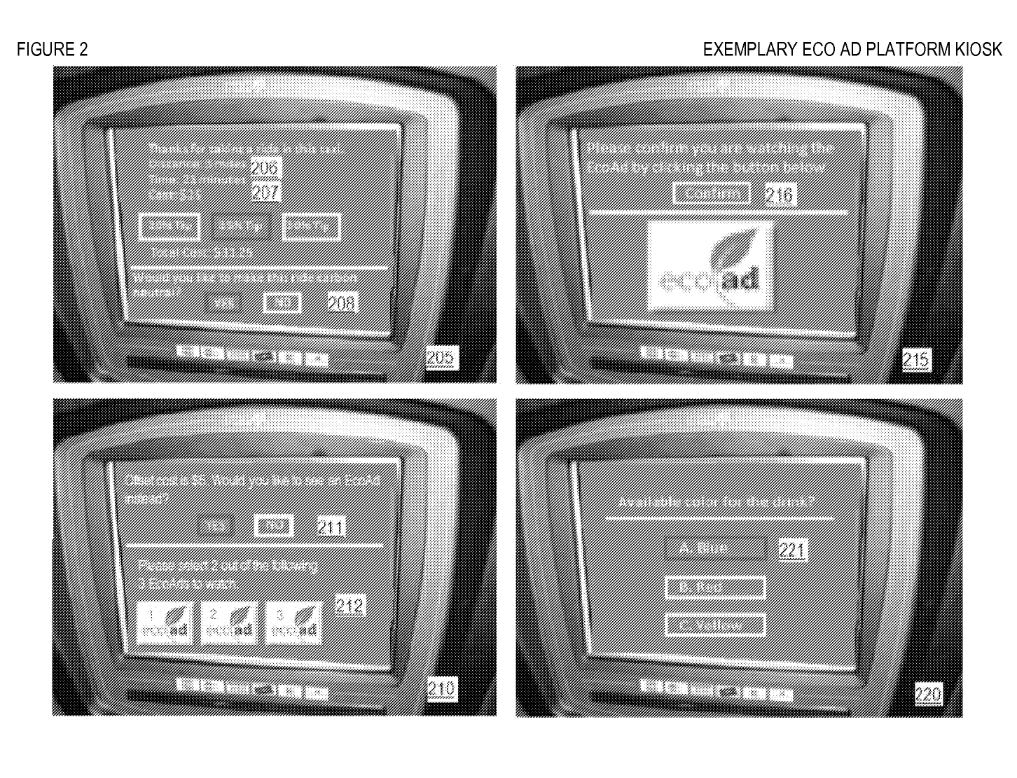

The leading number of each reference number within the drawings indicates the figure in which that reference number is introduced and/or detailed. As such, a detailed discussion of reference number would be found and/or introduced in FIG. 1. Reference number 201 is introduced in FIG. 2, etc.

### DETAILED DESCRIPTION

With advertisers and the industries they support becoming increasingly interested in environmental issues, there is a need for new approaches to more effectively link the advertising industry to ways of helping improve the environment.

### Introduction

The ECO AD PLATFORM introduces a new type of invested advertising, which helps finance environmental initiatives by investing a portion of collected proceeds from advertisers of certain advertising, such as EcoAds, into environmental projects to obtain positive environmental impact, to create jobs, to increase government revenues, and to generate EcoCredits (e.g., carbon credits, money, notes, commodities, securities, and/or the like). Such advertising affecting positive environmental impact, when, for example, certified by the ECO AD PLATFORM, may be branded as EcoAds. The environment could greatly benefit from a variety of environmental projects (e.g., projects to clean up rivers, to reduce fossil fuel usage and carbon emissions, to switch to more energy efficient equipment, and/or the like). Although such projects would benefit both the local population and the world community by reducing pollution and by facilitating a more sustainable and environmentally friendly way of life, unfortunately, many such environmental projects are never implemented due to lack of funding. While partial funding may be available for an environmental project (e.g., from a local government), unavailability of sufficient funding often prevents investors and others from fully capitalizing the environmental project.

The ECO AD PLATFORM helps finance such environmental projects by providing an opportunity for advertisers to use a portion of their advertising budget to provide partial funding for environmental projects of interest to the advertiser and/or to the advertiser's customers. Using the ECO AD PLATFORM the organizers of an environmental project may submit a project application to an EcoFacilitator describing the environmental project for consideration to become a funded EcoProject. Using the information provided in the project application, the EcoFacilitator may work with advertisers to select and fund projects of interest that would otherwise be unfunded. For example, the advertiser may choose to support environmental projects in the advertiser's local geographical area, and/or in the geographical area of the advertiser's customers (e.g., to help offset some of the environmental impact created by the advertiser). In another example, a manufacturer may choose to support efforts to clean up a polluted river near the manufacturer's production facility. Furthermore, by supporting environmental projects the advertiser may satisfy a green initiative set by the advertiser, the advertiser's customers, and/or the like.

In turn, the resulting advertisements (e.g., EcoAds) provide a premium advertisement platform that actually improves the environment and differentiates these advertisements from the traditional advertisements. For example, because advertisers often are willing to pay a certain amount of money for a consumer's attention (e.g., an ad impression), when a viewer watches an EcoAd, a portion of the advertiser impression payment may go to fund positive environmental projects. As such, when a consumer watches or interacts with an EcoAd, the consumer is actually positively affecting the environment by causing the funding of various positive environmental projects. Further, if the consumer were to have to choose between a traditional advertisement and an EcoAd, a consumer would have a preference toward the EcoAd.

Also, once the EcoFacilitator sources the project and provides sufficient funding obtained from advertisers for EcoAds, then a selected positive environmental project may commence. This in turn creates jobs, increases tax revenues, etc. in the locality, and also improves the environment. The EcoFacilitator may oversee the environmental project, measure the impact produced by the environmental project, and verify that the environmental project is producing a positive environmental impact. Once the project concludes and a positive environmental impact has been made, the ECO AD PLATFORM brings about the creation of EcoCredits (e.g., carbon credits, money, etc.), which may be distributed to any number of beneficiaries including the advertiser, the EcoFacilitator, the government, and/or other selected 3^{rd} parties. Often the resulting EcoCredits can more than offset the costs of the advertiser's investment in EcoAds as well as imparting value to other beneficiaries.

### ECO AD PLATFORM

The ECO AD PLATFORM facilitates positive environmental impact by a consumer in a variety of ways (e.g., by watching, listening, and/or interacting with an EcoAd, by paying for a carbon offset, and/or the like). The ECO AD PLATFORM may provide an opportunity for a user to select beneficiaries (e.g., local environmental projects) of project funding and/or EcoAd viewing and/or interactions. Although the use of the ECO AD PLATFORM is described mainly from the point of view of an EcoAd consumer, it is to be understood that users of the ECO AD PLATFORM may include various entities including an EcoAd Facilitator, a TV Network, an advertiser, third party intermediaries (e.g., the owner of a taxi with an EcoAd kiosk, an airline with EcoAd enabled media terminals, and/or the like), EcoProject organizers, investors, and/or other like 3^{rd} party beneficiaries. The ECO AD PLATFORM may be accessible through a variety of ways (e.g., via a kiosk, via a mobile application, via a website, via broadcast radio/television, and/or the like).

By watching an EcoAd, the consumer may benefit not only by learning about an advertiser's product, but also by knowing that the consumer is supporting an EcoProject of interest. For example, using the information provided by EcoProject organizers in project applications, the consumer may learn about various EcoAds benefiting certain EcoProjects; consumers may select an EcoAd/EcoProject that they care about (e.g., a local emissions reduction project). Furthermore, consumers may be provided an opportunity to show additional support for the EcoProject by providing confirmation that the consumer watched and/or comprehended the EcoAd. Consumer interactions with EcoAds may provide benefits to a number of beneficiaries, some of which may further support environmental projects. In addition to providing information to the consumer regarding an advertiser's product, an EcoAd may provide information regarding the EcoProject supported by the EcoAd. For example, the EcoAd may describe whether the EcoProject is fully funded; if not, how much money has to be generated for the EcoProject to be fully funded; if the EcoProject is in progress or has been completed; before and after pictures illustrating the positive environmental impact created by the EcoProject; etc. Furthermore, an EcoAd may educate a consumer regarding more environmentally friendly ways of performing an environment affecting activity. For example, the EcoAd may educate the consumer regarding the reduction in carbon emissions that would occur if the consumer rode a bus instead of driving. In many cases, completion of an EcoProject may generate EcoCredits the value of which may exceed the costs to an advertiser of supporting the EcoProject, and the EcoCredits may create value for all participants. Further proceeds generated by consumers watching EcoAds for the EcoProject may feed back additional EcoCredits, value, and positive environmental impact; for example, portions of payments from advertisers and any portion of EcoCredits generated from consumers' consumption of EcoAds (e.g., impressions) may be given to various beneficiaries (e.g., to fund new EcoProjects, to consumers and/or their selected friends, to advertisers, etc.).

FIG. 1 shows an exemplary usage scenario in one embodiment of the ECO AD PLATFORM. In FIG. 1, an advertiser 101 provides payment 104 (e.g., $1,000,000) for advertising services to a publisher such as a TV Network 103 with an understanding that part of the revenue (e.g., $100,000) is used to support environmental initiatives via an EcoFacilitator 105. The advertiser may provide payment for advertising services to the TV Network, and the TV Network may transfer part of the revenue to the EcoFacilitator. In return, the advertiser will be able to provide the public with premium branded EcoAds. In another embodiment, the advertiser may provide one part of the payment to the TV Network and another part of the payment to the EcoFacilitator.

The EcoFacilitator may support selected EcoProjects that provide positive environmental impact by providing seed, supplemental, and/or gap funding for the selected EcoProjects. For example, interested third parties such as a government 107 (e.g., local municipality, city government, state government, federal government, and/or the like), a local non-profit organization, an environmental organization (e.g., Greenpeace, World Wide Fund for Nature (WWF), International Union for Conservation of Nature (IUCN), and/or the like) may wish to implement a positive environmental project (e.g., a project to clean up a polluted river), but may not have enough funds available for the positive environmental project (e.g., a cleanup project). The EcoFacilitator, having received funds from (e.g., advertisers), may provide financing for the cleanup project that may encourage other investors, such as a bank 109, to provide additional financing for the cleanup project. In various embodiments, funding may be facilitated by an EcoFacilitator, by interested third parties, through use of B-Notes, and/or the like. With funding available, the EcoProject organizer may proceed with the cleanup project creating jobs and resulting in a positive environmental impact (e.g., a clean river).

In one embodiment, the government may allow the advertiser to publicize its support for an EcoProject (e.g., via a sign, billboard, and/or the like at the site of the cleanup project); this may be of particular value in controlled areas where advertisements are otherwise not allowed.

Also, the advertiser may provide payment for advertising services in response to a consumer 133a viewing the advertiser's EcoAd (e.g., via a client 133b, mobile device 133b, TV 120, Digital Video Recorder (DVR), and/or the like).

The completion of an EcoProject (e.g., in whole or in part) may generate EcoCredits such as carbon credits, money, notes, commodities, securities, and/or the like valuable assets. For example, carbon credits 113 may be awarded by a regulatory agency based on the environmental impact of the EcoProject. With the creation of EcoCredits, various beneficiaries may receive EcoCredit distributions; beneficiaries may include the EcoProject organizer, the government 107, the bank 109, the consumer 133a, the EcoFacilitator 105, the TV Network 103, the advertiser 101, and/or the like.

FIG. 2 shows a screen shot diagram illustrating an EcoAd kiosk in one embodiment of the ECO AD PLATFORM. The EcoAd kiosk (e.g., embedded in a taxi, a train, an airplane, a ship, a stationary Automated Teller Machine (ATM), and/or the like) may serve as a delivery mechanism for the EcoAd via the ECO AD PLATFORM including presenting a variety of information to the consumer regarding the environmental impact of the consumer's activity such as a taxi ride (e.g., on a touchscreen monitor embedded into the back of the taxi's front seat(s)). For example, as illustrated in screen 205, the kiosk may display the distance traveled 206, the time it took to travel 207, and/or the like. The information displayed to the consumer may be relevant to determining the environmental impact of the activity. Furthermore, the location of the activity may be relevant to determining the negative environment impact offset cost (e.g., EcoCredits may cost different amounts in different geographic locations). In one implementation, the kiosk may store geographic coordinates of its location (e.g., San Francisco). In another implementation, the kiosk may obtain its geographic coordinates using a global position system (GPS). The kiosk may store information regarding activity and/or activity metrics associated with the kiosk (e.g., offset cost per mile traveled in a plane).

The kiosk may prompt the consumer whether the consumer would like to make the ride carbon neutral 208. The consumer may be prompted at the beginning of the ride or during the ride. In another implementation, the consumer may be prompted at the end of the ride. As illustrated in screen 210, the kiosk may facilitate consumer selection of a payment method 211 for the offset amount (e.g., pay with a credit card or watch an EcoAd). The kiosk may also retrieve a suitable EcoAd (e.g., from local memory and/or from a remote database) and display it to the consumer 212. For example, the selection of a suitable EcoAd to display to the consumer and/or the desired payment method may take into account the location, profile information associated with the consumer, and/or other contextual variables. Consumer profile information may be retrieved from a server via a network connection (e.g., Bluetooth, cellular, WiFi, etc.) based on consumer identifying information provided by using a keyboard, a credit card, an radio-frequency identification (RFID) EcoAd fob, a smartphone with near field communications (NFC), a facial recognition scanner, a fingerprint scanner, a retinal scanner, and/or the like. Also, the profile information may be stored on and retrieved from the identification device. Such profile information may include the age, sex, nationality, socio-economic status, etc. of the consumer engaged with the ECO PLATFORM. Such information can be aggregated and analyzed to provide even more effective information including EcoAds to the consumer. In another example, the consumer may explicitly select one or multiple EcoAds to watch. The EcoAds from which the consumer may choose may be targeted to the consumer (e.g., as described in the preceding example). The kiosk may also facilitate obtaining confirmation that the consumer watched the EcoAd (e.g., via a user interface button) 215, 216 and/or comprehension of the EcoAd by the consumer (e.g., by recording the consumer's answer to a multiple-choice question) 220, 221. Providing confirmation, comprehension and/or additional profile information may earn the consumer additional EcoCredits and may provide additional funding for the EcoProject of interest to the consumer.

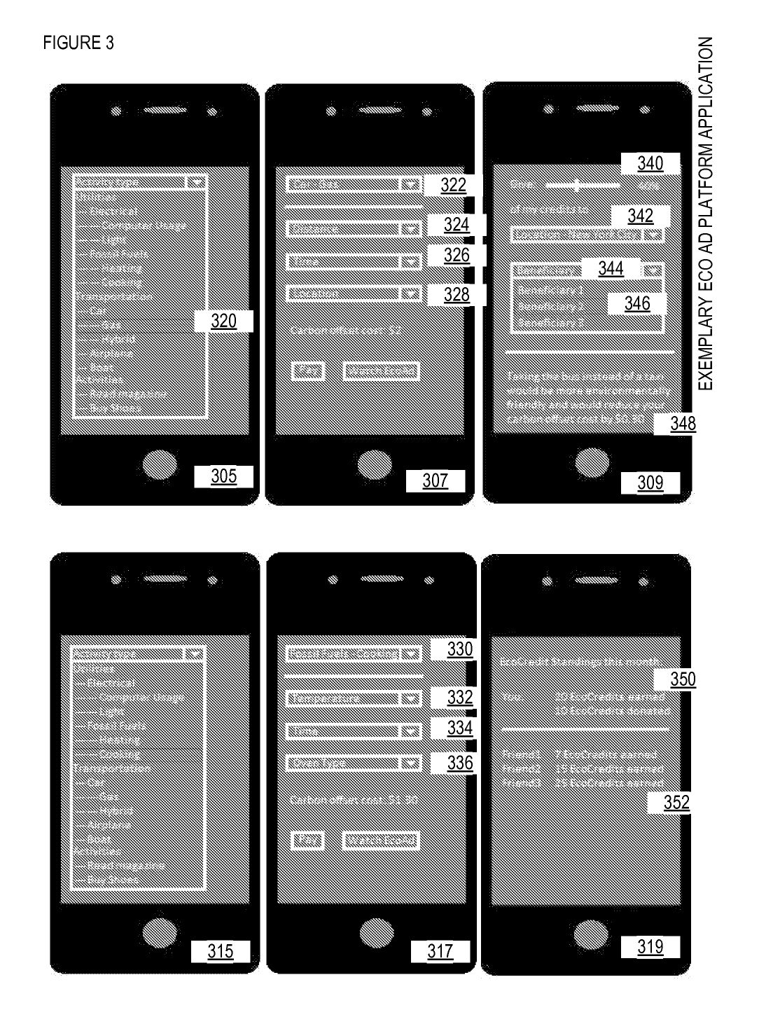

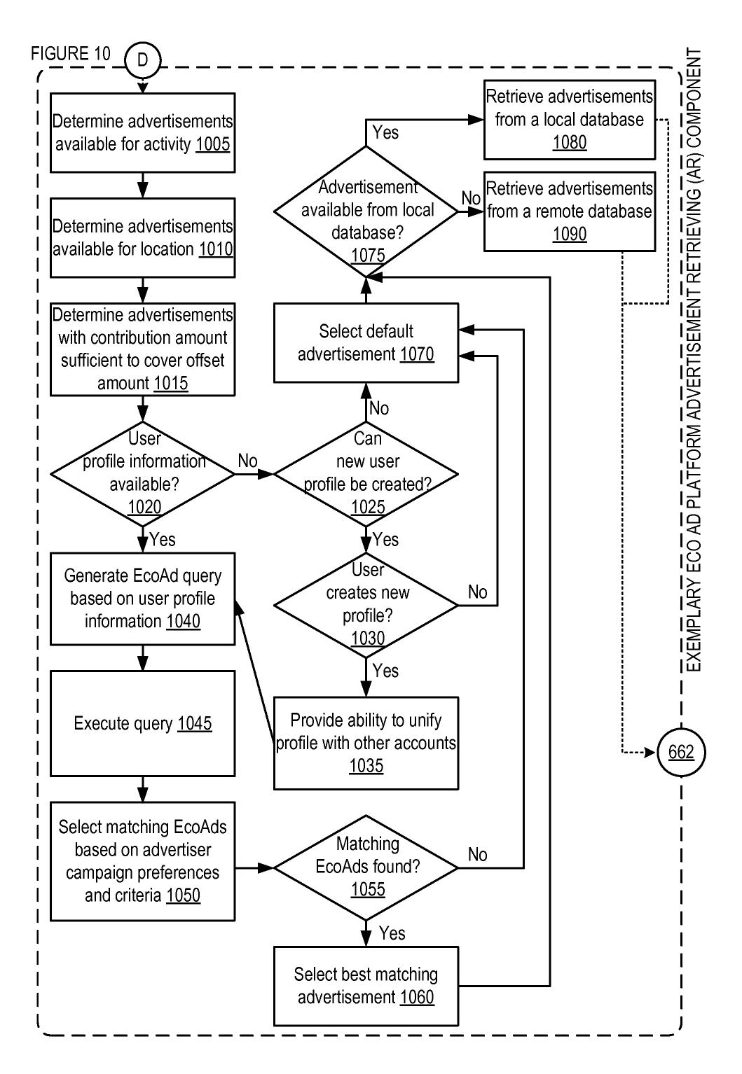

FIG. 3 shows a screen shot diagram illustrating an EcoAd application on a mobile device in one embodiment of the ECO AD PLATFORM. The EcoAd application may also be deployed via web-site, desktop application, set-top box, web browser plug-in, and/or the like platforms. In one embodiment, the EcoAd application is deployed in kiosks, thereby providing even greater flexibility at a kiosk. For example, in places where an EcoAd kiosk is not available, the consumer may use the mobile EcoAd application to offset carbon impact of an activity. The EcoAd application may facilitate inputting information regarding an activity the carbon impact of which the consumer would like to offset (e.g., by presenting a user interface allowing the user to select values of select boxes using a touchscreen of a mobile device). For example, such activities may include using utilities, using transportation, consumption activities (e.g., consuming food, natural resources, goods, services, etc.), positive environment impact activities (e.g., gardening), ordinary activities (e.g., going to the movies), and/or the like. Upon selection of the activity 320, the EcoAd application facilitates inputting details regarding the activity that may be helpful in determining the positive/negative environmental (e.g., carbon) impact of the activity. For example, as illustrated in screens 305 and 307, if the consumer is driving somewhere in a gas car 322, such details may include the distance 324, the time 326, the location 328, and/or the like information. For example, as illustrated in screens 315 and 317, if the consumer is cooking 330, such details may include the cooking temperature 332, the time 334, the oven type 336, and/or the like information. For some activities, the EcoAd application may obtain location information via a GPS of the mobile device. The EcoAd application may store information regarding activities and/or activity metrics associated with the stored activities (e.g., offset cost per minute of cooking in a gas oven at 400 degrees Fahrenheit), or may obtain them from a local and/or remote database. As illustrated in screens 307 and 317, the EcoAd application may facilitate consumer selection of a payment method for the offset amount 340 and 342 (e.g., pay with a credit card or watch an EcoAd). The EcoAd application may also retrieve (e.g., using a MediaLink field of the Advertisement data structure described in more detail in FIG. 10) a suitable EcoAd (e.g., from local memory, from a remote location via an internet connection, and/or the like) and display it to the consumer. The EcoAd application may also facilitate obtaining confirmation that the consumer watched the EcoAd (e.g., via a user interface “Confirm” button) and/or comprehension of the EcoAd by the consumer (e.g., by recording the consumer's answer to a multiple-choice question and sending it to a web server) as well as additional profile information regarding the consumer.

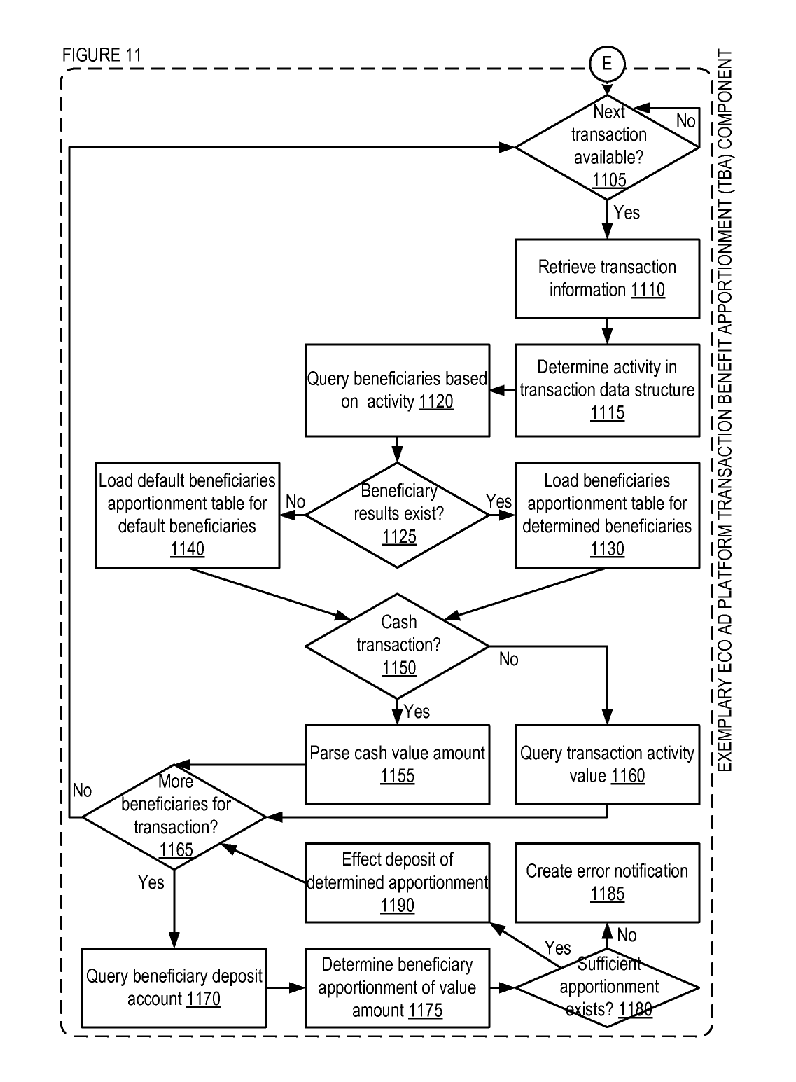

The EcoAd application may be used by the consumer to select beneficiaries that may receive EcoCredits earned by the consumer by watching the EcoAd. As illustrated in screen 309, the consumer may select an amount of EcoCredits to be awarded 340. The consumer may also select the location of the intended beneficiary 342 (e.g., based on the consumer's current location, consumer's preferences, and/or the like). The EcoAd application may display beneficiaries in the selected location 344 to the consumer (see FIG. 11 for more details regarding an example Beneficiary data structure), and the consumer may select an intended beneficiary 346. For example, the consumer may wish to donate EcoCredits to a local charity, to a local EcoProject, to the local municipality, and/or the like. Since many environmental issues have local ties, consumers may want to ensure that their EcoCredits are going to an environmental project that is located where they live and/or where they are currently located and impacting the environment. Accordingly, a stronger tie may exist between the EcoAd and the consumer as the consumer may view watching the advertisement not only as being informative, but also as helping to contribute a benefit back to the environment that the consumer may direct to a location/EcoProject as the consumer deems fit. Providing the consumer with updates regarding the EcoProject's progress (e.g., how much of the project has already been funded, how much funding remains to be obtained, how the EcoProject has benefitted the consumer, and/or the like) may make the tie even stronger. Furthermore, such stronger emotional ties (e.g., connection with the EcoProject, location, and/or the like) may further facilitate the consumer to increase his/her contribution. In one embodiment, the ECO AD PLATFORM may connect with such social-oriented service organizations (e.g., micro-loans), such as kiva.org, to facilitate beneficiary selection. Also, consumers may select friends in their social graph, for example, friends from Facebook, LinkedIn, their instant messenger buddy list, twitter, email contacts, and/or the like.

Furthermore, the EcoAd application may provide educational messages to the consumer 348 (e.g., to help the consumer reduce their environmental impact in the future). For example, the EcoAd application may inform the consumer that taking a bus instead of riding a taxi would be more environmentally friendly and may provide information regarding the amount of carbon dioxide that would not be released into the atmosphere and the reduced environmental offset costs if the consumer takes the bus.

The EcoAd application may also be used by the consumer to view EcoCredit statistics (e.g., cumulative total amount of EcoCredits generated by the consumer, EcoCredits generated by the consumer this month, the amount of EcoCredits donated to an EcoProject, the amount of EcoCredits donated to a charity, and/or the like) and/or compare the amount of EcoCredits generated/donated by the consumer 350 to those of the consumer's friends or associates 352 (e.g., compared to other people that used a kiosk, other people that rode in a cab, the consumer's friends on social networks, and/or the like), as illustrated in screen 319. For example, providing such statistics may promote friendly competition between friends to see who earns the most EcoCredits, who donates the most EcoCredits, and/or the like, and may motivate consumer behavior generating EcoCredits (e.g., choosing certain products/services because they generate higher EcoCredits than other products/services). Additional game mechanics (e.g., earning badges for achieving certain levels of EcoCredits or supporting certain projects) may also be used to further motivate consumers' behavior in engaging more regularly with the ECO AD PLATFORM.

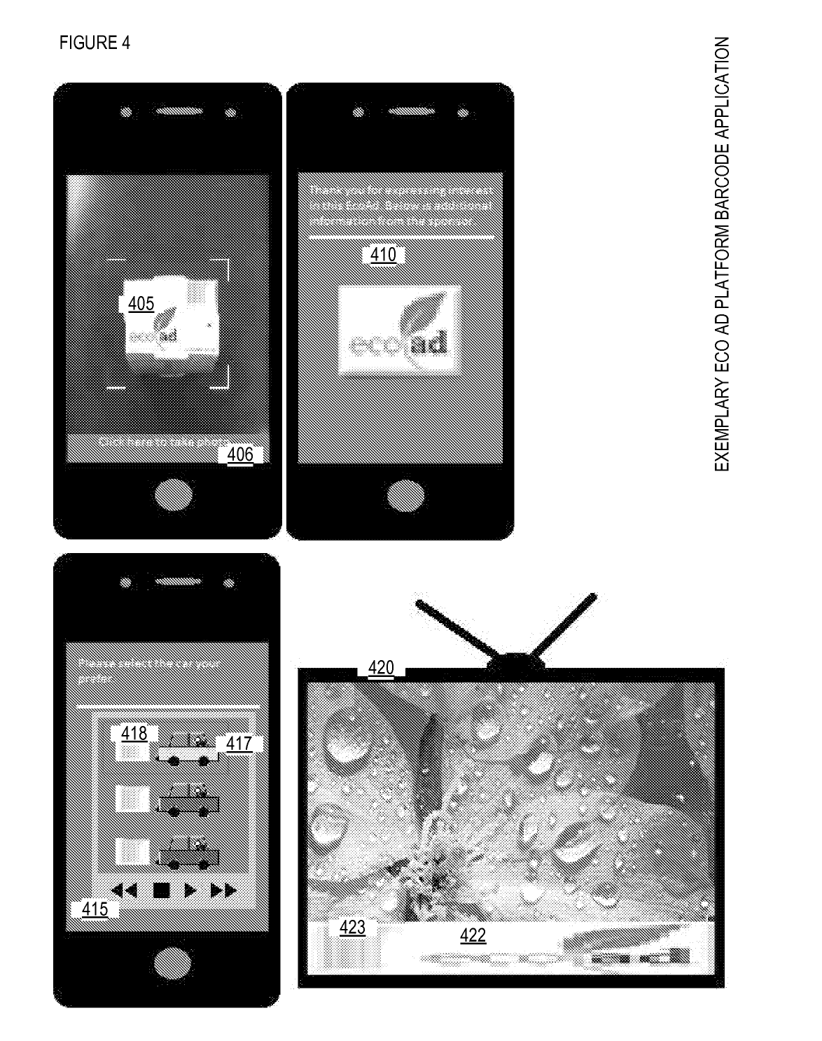

FIG. 4 shows a screen shot diagram illustrating an EcoAd barcode application in one embodiment of the ECO AD PLATFORM. In one implementation, the EcoAd barcode application may be a separate application. In another implementation, the EcoAd barcode application may be a part of the EcoAd application. In FIG. 4, a barcode-linked EcoAd 405 may be viewed by the consumer (e.g., a print EcoAd, a billboard EcoAd, a TV EcoAd, a radio EcoAd, and/or the like). In one implementation, a barcode may be a visual image (e.g., a linear barcode, a 2D barcode, and/or the like). In another implementation, a barcode may be an audio mnemonic (e.g., a jingle, a tune, and/or the like). For example, audio identification technologies, such as Shazam, may be used to identify an audio mnemonic and/or to detect identifying information (e.g., carried in a high frequency audio band inaudible to human ear) carried by an audio mnemonic. The consumer may earn EcoCredits by taking a snapshot of a visual barcode 406 and/or recording the tune of an audio mnemonic using the EcoAd barcode application. For example, taking the snapshot of the barcode may serve as a confirmation to the advertiser that the barcode-linked EcoAd was viewed by the consumer and may provide EcoAd usage statistics to the advertiser regarding who viewed the EcoAd (e.g., based on the EcoID of the consumer, the GPS information regarding the consumer's location, and/or the like). This is of particular value in one-way advertising channels normally incapable of confirming ad impressions such as billboards, print advertising, broadcast radio/television, and/or the like. Such one-way advertising channels may participate in the ECO AD PLATFORM by including barcodes, for example, by printing barcodes on billboards and print ads, providing discernable audio prints, placing barcodes in banner overlays on television. For example, an EcoAd with a barcode displayed on a television is illustrated at 420. The EcoAd 422 overlays a television program, online video, and/or the like video, and the application user may obtain EcoCredits by taking a picture of the barcode 423 associated with the EcoAd. Also, such barcodes may even be placed in two-way advertising channels for enhanced experiences; for example, placing a barcode in web banner ad might allow the mobile EcoAd application user to snap the ad and obtain credit for consuming an EcoAd associated with his/her profile while snapping the EcoAd on a friends computer. In another example, an online video EcoAd about cars may be displayed (e.g., on a computer monitor) and a picture of the video (e.g., as displayed on the computer monitor) may be taken using a mobile device as illustrated at 415. The application user may obtain EcoCredits by selecting a car that the user liked 417 after seeing the EcoAd video using the barcode 418. In response to taking the snapshot of the barcode, the EcoAd barcode application may provide additional information 410 from the advertiser to the consumer. In one embodiment, the EcoAd barcode application may inform the consumer regarding the amount of EcoCredits earned by the consumer. In one implementation, the EcoCredits earned by the consumer may be used to offset carbon impact of a future activity, may be gifted to a charity or a friend, and/or the like.

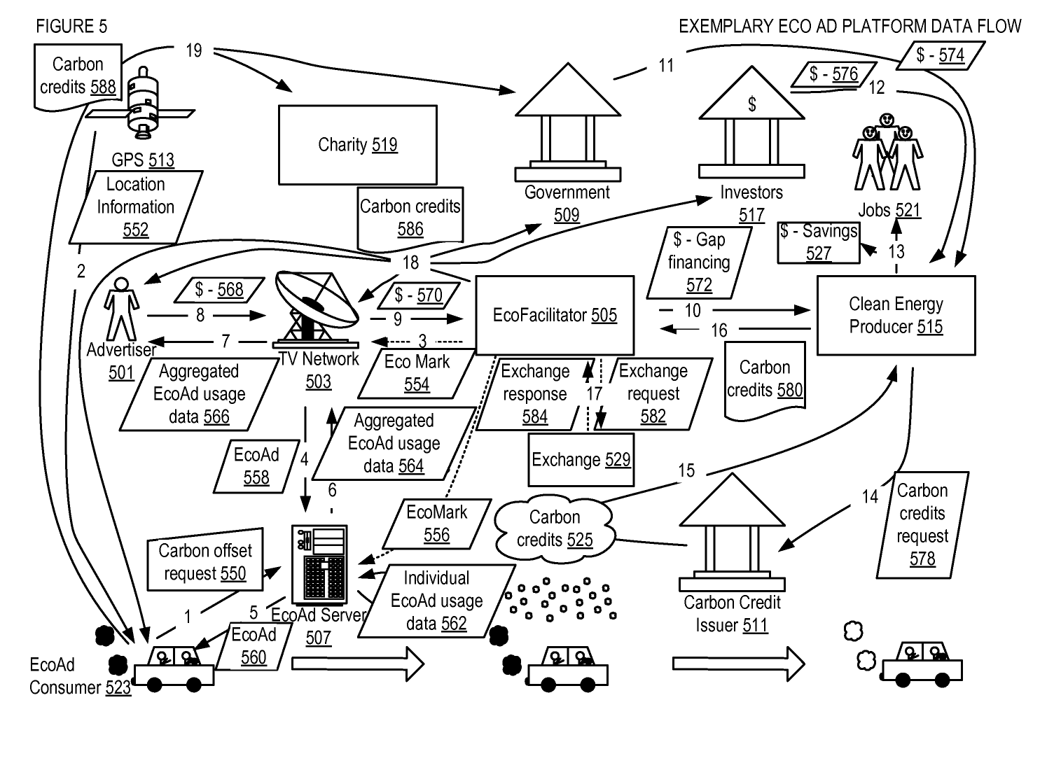

FIG. 5 shows a data flow diagram in one embodiment of the ECO AD PLATFORM. This data flow begins with a negative environment impact (e.g., carbon) offset request 550 (see examples below) from an EcoAd consumer 523 that is received by an EcoAd Server 507. For example, the EcoAd consumer may be riding in a taxi, a train, an airplane, a ship, and/or the like, and may wish to offset the carbon impact of the ride. In another example, the EcoAd consumer may be cooking, and may wish to offset the carbon impact of using a gas stove. Any negative environment impacting activities may be offset. In one embodiment, the carbon offset request may be received from a kiosk (e.g., a kiosk embedded in the taxi). For example, the carbon offset request may be in XML format substantially in the following form:

```
<XML>
      <CarbonOffsetRequest>
            <UserID>ID123</UserID>
            <OffsetType>EcoAd</OffsetType>
            <OffsetAmount>$1</OffsetAmount>
            <KioskID>ID321</KioskID>
            <KioskLocation>New York City</KioskLocation>
      </CarbonOffsetRequest>
</XML>
```

The carbon offset request may include a UserID identifying the consumer. In one implementation, the UserID may correspond to the ConsumerID of the consumer in the Consumer data structure (see FIG. 10 for more details regarding the Consumer data structure). In another implementation, the UserID may correspond to the LoginName of the consumer in the Consumer data structure.

See FIG. 2 for additional details regarding an ECO AD PLATFORM kiosk. In another embodiment, the carbon offset request may be received from an ECO AD PLATFORM application (e.g., a desktop, a mobile, a web-based application, and/or the like). For example, the carbon offset request may be in XML format substantially in the following form:

```
<XML>
      <CarbonOffsetRequest>
            <UserID>ID456</UserID>
            <ActivityType>Cooking</ActivityType>
            <ActivitySubType>Gas Stove</ActivitySubType>
            <OffsetType>Cash</OffsetType>
            <OffsetAmount>$2</OffsetAmount>
            <ApplicationVersion>v1.1</ApplicationVersion>
            <DeviceLocation>San Francisco</DeviceLocation>
      </CarbonOffsetRequest>
</XML>
```

See FIG. 3 for additional details regarding an ECO AD PLATFORM application. In yet another embodiment, the carbon offset request may be received as a result of the consumer interacting with a barcode-linked EcoAd (e.g., a print EcoAd, a billboard EcoAd, a TV EcoAd, a radio EcoAd, and/or the like) via an ECO AD PLATFORM barcode application. See FIG. 4 for additional details regarding an ECO AD PLATFORM barcode application. The ECO AD PLATFORM barcode application may be a part of the ECO AD PLATFORM application. For example, the carbon offset request may be in XML format substantially in the following form:

```
<XML>
      <CarbonOffsetRequest>
            <UserID>ID789</UserID>
            <OffsetType>Barcode</OffsetType>
            <OffsetAmount>$1</OffsetAmount>
            <Location>New York City</Location>
            <EcoAdID>ID987</EcoAdID>
            <BarcodeImage>image1</BarcodeImage>
            <BarcodeID>BarID123</BarcodeID>
      </CarbonOffsetRequest>
</XML>
```

The carbon offset request may include location information (e.g., regarding the consumer's location). A GPS device 513 may provide location information 552 associated with a consumer's mobile device (e.g., a cell phone).

The EcoFacilitator 505 may certify an advertisement with an EcoMark 554, 556 (e.g., a green label) to indicate that the advertisement is an EcoAd. For example, the certification may be done using public key cryptography to verify that the advertisement sent for certification came from an authorized advertiser. For example, a digitally signed advertisement may be sent to the EcoFacilitator encrypted using an advertiser's private key. The EcoFacilitator may determine the advertiser using the identifying information in the digital signature, verify that the advertiser is an authorized advertiser by checking the advertiser's ID against a list of IDs of authorized advertisers, retrieve the advertiser's public key (e.g., from a database that maps advertiser IDs to public keys), and decrypt the digitally signed advertisement. If the decryption is successful, the EcoFacilitator may certify the advertisement as an EcoAd. Also, the EcoFacilitator may certify EcoAds and place them on the EcoAd Server 507. In another implementation, the EcoFacilitator may certify EcoAds available from the TV Network 503, and the TV Network may place the EcoAds 558 on the EcoAd Server. An EcoAd 560 may be played back to the EcoAd consumer 523 in response to receiving a carbon offset request. For example, an EcoAd may take the form of an image (e.g., JPEG, GIF, PNG, and/or the like), video (e.g., MPEG2, H264, and/or the like), audio (MP3, AAC, WMA, and/or the like), and/or the like. EcoAd identifying information (e.g., see FIG. 10 for more details regarding the Advertisement data structure) may be encoded in a file containing the EcoAd (e.g., the file may be tagged with identifying information using the ID3 tags using MP3 audio format).

Individual EcoAd usage data regarding individual transactions may be recorded by the EcoAd server. Such captured usage data may be aggregated for analytics and feedback into the ECO AD PLATFORM to improve future EcoAds and ECO AD PLATFORM performance. Such individual EcoAd usage data may include information regarding which EcoAd a consumer watched, the length of the EcoAd, whether the consumer confirmed viewing the EcoAd, whether the consumer understood the EcoAd, whether the consumer liked the EcoAd, demographic information regarding the consumer and/or the like. For example, the individual EcoAd usage data may be in XML format substantially in the following form:

```
<XML>
    <IndividualAdUsageData>
        <EcoAdID>ID223</EcoAdID>
        <EcoAdType>Web</EcoAdType>
        <ViewTime>30 seconds</ViewTime>
        <Confirmation>Yes</Confirmation>
        <Comprehension>No</Comprehension>
        <ComprehensionQuestionID>ID1</ComprehensionQuestionID>
        <ComprehensionAnswer>C. Yellow</ComprehensionAnswer>
        <LikedEcoAd>Yes</LikedEcoAd>
    </IndividualAdUsageData>
</XML>
```

Aggregate EcoAd usage data 564, 566 regarding EcoAds may be provided (e.g., by the EcoAd Server 507) to the TV Network 503 and/or to the advertiser 501. For example, the aggregate EcoAd usage data may include information such as which EcoAds were viewed, whether the consumers confirmed that the consumers saw an EcoAd, whether the consumers understood the content of an EcoAd, whether the consumers liked an EcoAd, the number of times an EcoAd was shown to the consumers, demographic information regarding viewers of an EcoAd, location information regarding viewers of an EcoAd and/or the like. Such aggregate EcoAd usage data may be in XML format substantially in the following form:

```
<XML>
    <AggregateAdUsageData>
        <EcoAdID>ID234</EcoAdID>
        <EcoAdType>Web</EcoAdType>
        <Usage>
            <Location>New York City</Location>
            <ViewerDemographics>
                <Age_19_to_24>15%</Age_19_to_24>
                ...
                <Gender_Male>45%</Gender_Male>
                ...
            </ViewerDemographics>
            <AverageViewTime>30 seconds</AverageViewTime>
            <Confirmation>40%</Confirmation>
            <Comprehension>25%</Comprehension>
        </Usage>
        <Questions>
            <Question>
                <QuestionID>ID1</QuestionID>
                <Text>Available color for the drink?</Text>
                <Answer>
                    <Text>A. Blue</Text>
                    <Correct>Yes</Correct>
                    <Answered>50%</Answered>
                </Answer>
                <Answer>
                    <Text>B. Red</Text>
                    <Correct>No</Correct>
                    <Answered>30%</Answered>
                </Answer>
                <Answer>
                    <Text>C. Yellow</Text>
                    <Correct>No</Correct>
                    <Answered>20%</Answered>
                </Answer>
            </Question>
        </Questions>
        ...
    </AggregateAdUsageData>
</XML>
```

Individual and/or aggregate EcoAd usage data may be used (e.g., by the advertiser 501), to determine the payment amount 568, 570 that the advertiser should pay to the TV Network 503 and/or to the EcoFacilitator 505 as a result of the EcoAd consumer 523 watching the advertiser's EcoAd. See FIG. 10 for additional details regarding how the payment amount associated with an EcoAd may be determined.

The EcoFacilitator 505 may provide financing 572 (e.g., seed, supplemental, and/or gap funding) to an EcoProject organizer (e.g., clean energy producer 515, environment (e.g., water, air, and/or the like) cleanup entity, and/or the like) for an EcoProject (e.g., construction of a solar power plant) using funds received from advertisers. With funding available, the EcoProject organizer may obtain additional funding 574, 576 from other sources such as a government 509 (e.g., local municipality, city government, state government, federal government, and/or the like), investors 517 (e.g., banks, venture capitalists, and/or the like), and/or the like and may proceed with the EcoProject. Positive impact of the EcoProject may include cleaner environment, local jobs 521 (e.g., to build and/or operate the EcoProject), additional tax revenue, lower energy costs, savings 527 (e.g., from operating a more efficient power plant), and/or the like.

The EcoProject (e.g., producing solar energy) may qualify the EcoProject organizer to receive environmental credits (e.g., carbon credits 525 such as Renewable Energy Certificates (RECs)) from a certifying agency (e.g., a Carbon Credit Issuer 511 such as Green-e). The EcoProject organizer may complete an application, such as the Green-e Energy Certification Contract to qualify. For example, the clean energy producer 515 may send a carbon credits request 578 to the carbon credit issuer 511, and the carbon credits issuer 511 may issue carbon credits 525 to the clean energy producer 515. In one implementation, the carbon credits request may be for energy produced, may be in XML format substantially in the following form:

```
<XML>
      <CarbonCreditsRequest>
            <EntityID>ID345</EntityID>
            <EntityType>Utility</EntityType>
            <EntitySubType>Electricity Producer</EntitySubType>
            <ElectricityProduced>5,000 MWh</ElectricityProduced>
            <ElectricityType>Solar</ElectricityType>
            <Location>San Francisco</Location>
      </CarbonCreditsRequest>
</XML>
```

In another implementation, the carbon credits request may be for efficiency produced (e.g., less electricity used for production), may be in XML format substantially in the following form:

```
<XML>
      <CarbonCreditsRequest>
            <EntityID>ID346</EntityID>
            <EntityType>Manufacturer</EntityType>
            <EntitySubType>Cars</EntitySubType>
            <EfficiencyProduced>500 MWh</EfficiencyProduced>
            <Location>Detroit</Location>
      </CarbonCreditsRequest>
</XML>
```

In yet another implementation, the carbon credits request may be for emission reduction produced (e.g., less carbon used for production), may be in XML format substantially in the following form:

```
<XML>
    <CarbonCreditsRequest>
        <EntityID>ID347</EntityID>
        <EntityType>Manufacturer</EntityType>
        <EntitySubType>Cars</EntitySubType>
        <EmissionReductionType>Carbon Dioxide</
        EmissionReductionType>
        <EmissionReductionAmount>670K lbs</
        EmissionReductionAmount>
        <Location>Detroit</Location>
    </CarbonCreditsRequest>
</XML>
```

Carbon credits may take on the form of digital certificates tracked through a tracking system (e.g., WREGIS, NEPOOL, GATS, ERCOT, M-RETS, and/or the like). Carbon credits may also be tracked by the ECO AD PLATFORM database. Carbon credits generated by the EcoProject as a result of the consumer watching an EcoAd may rectify a consumer's carbon impact (e.g., of the consumer's taxi ride).

Carbon credits 580, 586, 588 may be exchanged for other assets (e.g., for money, notes, commodities, securities, and/or the like) on an EcoCredit exchange 529. Accordingly, such other assets may be distributed instead of carbon credits at 580, 586, 588. Carbon credits may be exchanged by sending an exchange request 582 to the EcoCredit exchange (e.g., the Chicago Climate Exchange (CCX)). For example, the exchange request may be in XML format substantially in the following form:

```
<XML>
      <ExchangeRequest>
            <RequestID>ID888</RequestID>
            <EntityID>ID555</EntityID>
            <EntityAccountNumber>65656</EntityAccountNumber>
            <OrderNumber>34569687</OrderNumber>
            <FromType>carbon credits</FromType>
            <FromAmount>100</FromAmount>
            <ToType>US dollars</ToType>
            <OrderType>Market</OrderType>
            <OrderDuration>Day</OrderDuration>
      </ExchangeRequest>
</XML>
```

The EcoCredit exchange may respond with an exchange response 584 (e.g., indicating whether the exchange request was successful). For example, the exchange response may be in XML format substantially in the following form:

```
<XML>
      <ExchangeResponse>
            <ResponseID>ID999</ResponseID>
            <EntityID>ID555</EntityID>
            <OrderNumber>34569687</OrderNumber>
            <OrderStatus>Executed</OrderStatus>
            <ExchangePriceType>US dollars</ExchangePriceType>
            <ExchangePricePerUnitAmount>300</
            ExchangePricePerUnitAmount>
            <TotalReceivedAmount>30,000</TotalReceivedAmount>
      <ExchangeResponse>
</XML>
```

Carbon credits 580, 586, 588 may be distributed among a variety of entities (e.g., based on contractual agreements associated with providing funding for the EcoProject). For example, carbon credits beneficiaries may include the EcoProject organizer, the EcoFacilitator 505, the investors 517, the government 509, the TV Network 503, the advertiser 501, the EcoAd consumer 523, specified third parties, and/or the like. The ECO AD PLATFORM may facilitate user selection of beneficiaries of the carbon credits 588 awarded to the user. For example, the consumer may elect to keep the carbon credits, give the carbon credits to a charity and/or nonprofit organization 519, give the carbon credits to a local municipality 509, give the carbon credits to a friend, and/or the like.

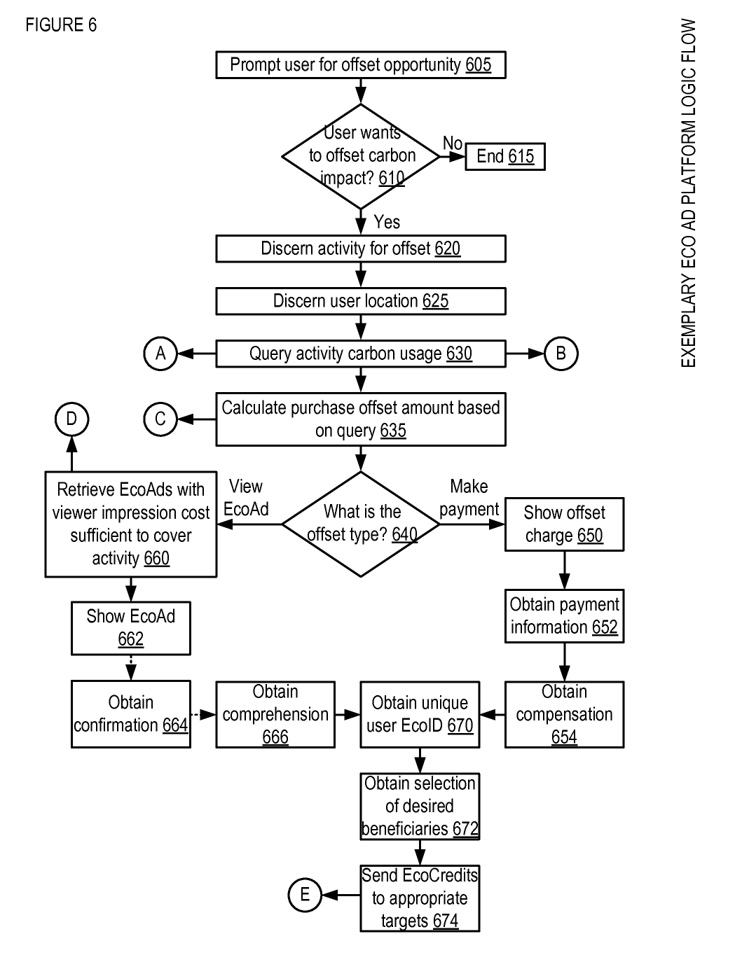

FIG. 6 shows a logic flow diagram illustrating offsetting a consumer's carbon impact in one embodiment of the ECO AD PLATFORM. For example, this logic may be used to implement the EcoAd Kiosk (see FIG. 2), EcoAd application (see FIG. 3), and/or the like. In FIG. 6, the consumer may be prompted for an offset opportunity at 605. Consumers may be riding in a taxi, a train, an airplane, a ship, and/or the like, and may wish to offset the carbon impact of the ride. Alternatively, a consumer may be cooking, and may wish to offset the carbon impact of using a gas stove. In one embodiment, the consumer may be prompted by an ECO AD PLATFORM kiosk (e.g., at the beginning or end of the taxi ride) via the kiosk's user interface. See FIG. 2 for additional details regarding an ECO AD PLATFORM kiosk. In another embodiment, the prompting may take the form of the consumer activating an ECO AD PLATFORM application (e.g., a desktop, a mobile, a web-based application and/or the like). See FIG. 3 for additional details regarding an ECO AD PLATFORM application. In yet another embodiment, the prompting may take the form of the consumer interacting with a barcode-linked EcoAd (e.g., a print EcoAd, a billboard EcoAd, a TV EcoAd, a radio EcoAd, and/or the like) via an ECO AD PLATFORM barcode application. In one implementation, the ECO AD PLATFORM barcode application may be a part of the ECO AD PLATFORM application. See FIG. 4 for additional details regarding an ECO AD PLATFORM barcode application.

A determination may be made at 610 whether the consumer wants to offset a negative environmental impact (e.g., polluting air, polluting water, using excessive amount of electricity, and/or the like) such as carbon impact. If the consumer does not wish to offset carbon impact, the ECO AD PLATFORM logic flow ends at 615. Otherwise, the ECO AD PLATFORM discerns activity for offset at 620. For example, the activity may be a taxi ride in a gas car. As such, the activity type may be preset (e.g., a kiosk in a gas car may be preset with taxi ride in a gas car activity type). In another embodiment, the consumer may select the activity type (e.g., via a user interface—for example, see FIG. 3). At 625 the consumer's location may be discerned. The consumer's location may be discerned based on coordinates provided by a GPS toolkit (e.g., of a mobile device equipped with a GPS). In one implementation, Google's Android operation system's (OS's) Location Manager may be used substantially as follows:

```
LocationManager locationManager =
(LocationManager)
this.getSystemService(Context.LOCATION_SERVICE);
LocationListener locationListener = new LocationListener( )
{
    public void onLocationChanged(Location geoLocation) {
      provideNewLocation(geoLocation);
    }
};
locationManager.requestLocationUpdates(LocationManager.-
NETWORK_PROVIDER, 0, 0, locationListener);
locationManager.requestLocationUpdates(LocationManager.-
GPS_PROVIDER, 0, 0, locationListener);
```

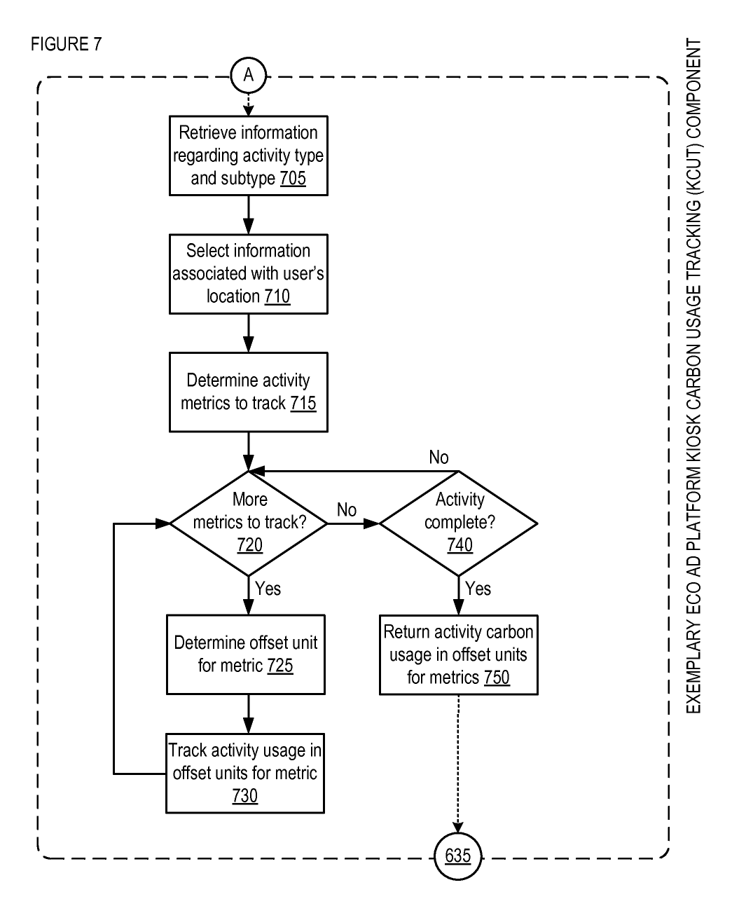

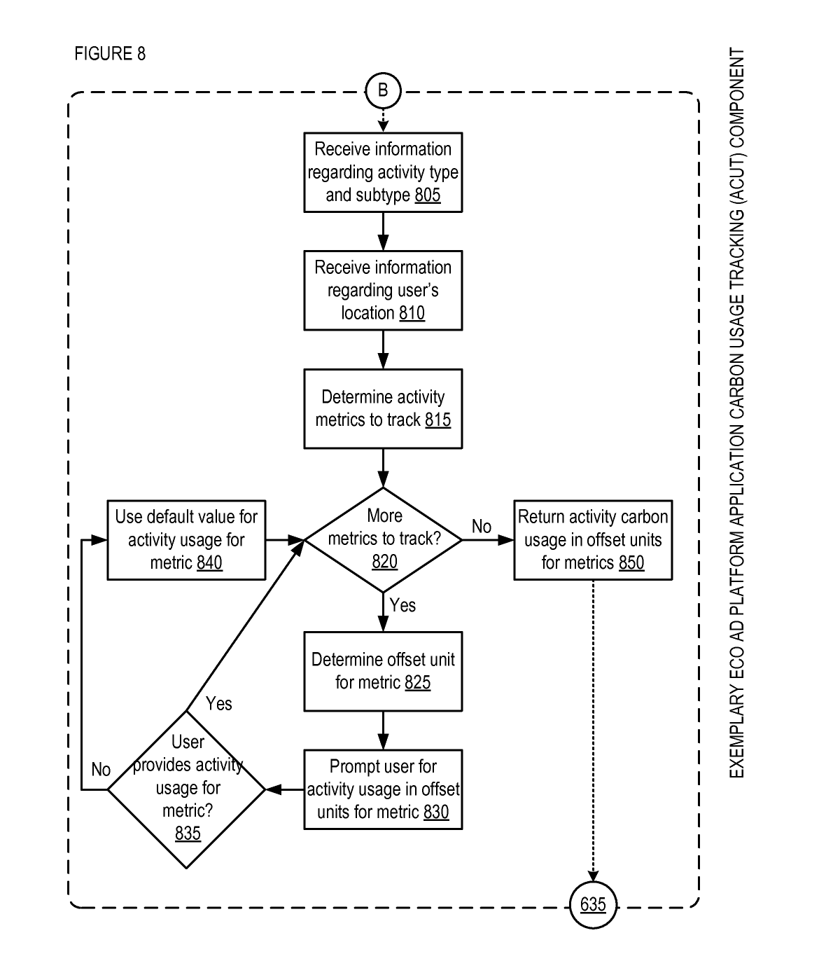

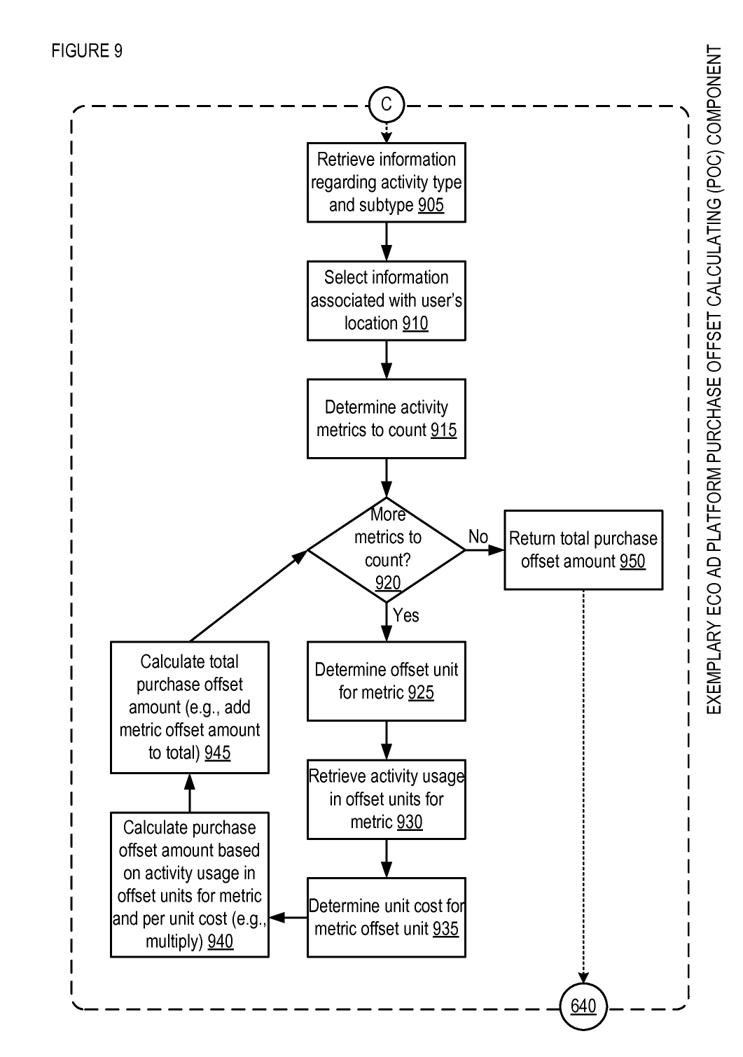

The returned geolocation may be used for location based queries thereafter. In another implementation, toolkits for Apple's iOS, Palm's WebOS, and/or the like may be used. In another embodiment, the consumer's location may be discerned based on information supplied by the consumer. In yet another embodiment, the consumer's location may be discerned based on preset information (e.g., location information of a stationary kiosk in a store). Activity carbon usage may be queried at 630 (e.g., based on a variety of metrics associated with the activity, location, and/or the like). In one embodiment, activity carbon usage may be determined based on actual carbon impact (e.g., a tailpipe emissions measuring device). In another embodiment, activity carbon usage may be determined using a statistical model. See FIGS. 7 and 8 for additional details regarding querying activity carbon usage. Purchase offset amount may be calculated based on the query at 635. The purchase offset amount may represent a monetary value of the consumer's carbon impact due to the activity. The purchase offset amount may be calculated based on (e.g., by summing) costs associated with various metrics tracked for the activity (see FIG. 9 for additional details regarding calculation of the purchase offset amount). The consumer may choose the locality to benefit from the purchase offset payment, which may affect the purchase offset amount.

A determination may be made at 640 regarding how the consumer wants to pay for the carbon offset. In one embodiment, the consumer may choose to make a payment (e.g., using a credit card, a bank account, and/or the like) to pay for the carbon offset. The consumer may enter their payment type selection and information associated with the consumer's preferred payment method via a number of input mechanisms including a touch screen keyboard into user interface elements displayed on the screen (e.g., text fields of a web form), swiping a credit card past a magnetic/RFID reader, passing an NFC capable smartphone, and/or the like. The consumer may be informed regarding the purchase offset amount (e.g., shown the charge on a screen) at 650. Payment information may be obtained from the consumer at 652 (e.g., the consumer's credit card number, bank account number, and/or the like), and compensation may be obtained at 654. In another embodiment, the consumer may choose to view EcoAds to pay for the carbon offset. EcoAds (e.g., one or multiple) with viewer impression cost sufficient to cover the offset amount for the activity may be retrieved at 660. See FIG. 10 for additional details regarding retrieving suitable EcoAds. The retrieved EcoAd may be shown to the consumer at 662. In one embodiment, the advertiser may pay a higher rate for watching the EcoAd if the advertiser receives confirmation that the consumer watched the EcoAd, and or comprehended the EcoAd. For example, a confirmation may be obtained from the consumer 664 that the consumer watched the EcoAd (e.g., the consumer may click a button on a screen to confirm that the consumer did not leave the taxi prior to finishing watching the EcoAd). In another example, comprehension of the EcoAd by the consumer may be obtained at 666 (e.g., an advertiser may show an EcoAd regarding a sports drink and may present a consumer with a multiple-choice question regarding the flavors in which the sports drink is available). The ECO AD PLATFORM may display information (e.g., pictures, video, and/or the like) to the consumer regarding the EcoProject that was helped by watching the EcoAd.

If the consumer has an account with the ECO AD PLATFORM, the ECO AD PLATFORM may obtain the consumer's unique EcoID at 670. For example, the consumer's account may indicate consumer preferences regarding which types of EcoAds the consumer prefers to watch, may include a list of preferred beneficiaries to receive EcoCredits, and/or the like. The consumer's profile may be retrieved using a SQL query substantially in the following form:

SELECT Preferences_AdContentType, Preferences_Advertisers,
Preferences_Beneficiaries
FROM Consumer
WHERE ConsumerID = “CID1”

The selection of desired beneficiaries may be received from the consumer at 672. In one implementation, the consumer may select the desired beneficiaries from a list of preferred beneficiaries (e.g., see FIG. 11 for more details regarding Beneficiary data structure). In another implementation, the consumer may select beneficiaries from a list presented by the ECO AD PLATFORM based on activity information (e.g., see FIG. 7 for more details regarding Activity data structure). In yet another implementation, the consumer may choose to have the ECO AD PLATFORM select the beneficiaries (e.g., based on a list containing default beneficiaries). The EcoCredits may be sent to appropriate targets at 674. For example, the EcoCredits accounts of beneficiaries may be credited the appropriate amount. See FIG. 11 for additional details regarding apportioning benefits.

FIG. 7 shows a logic flow diagram illustrating a kiosk carbon usage tracking (KCUT) component in one embodiment of the ECO AD PLATFORM. For example, the KCUT component may be used to track carbon usage of an activity in an EcoAd kiosk (e.g., in a taxi). The Activity data structure may be used to help determine the carbon impact of an activity and may be in XML format substantially in the following form:

```
<XML>
<Activity>
  <ActivityID>AID1</ActivityID>
  <ActivityType>
    <ActivityTypeName>Cab Ride</ActivityTypeName>
    <ActivitySubType>
      <ActivitySubTypeName>Old Gas Car</ActivitySubTypeName>
      <Offset>
        <OffsetUnit>minute</OffsetUnit>
        <UnitCost>$0.20</UnitCost>
      </Offset>
    </ActivitySubType>
    <ActivitySubType>
      <ActivitySubTypeName>New Hybrid Car</ActivitySubTypeName>
      <Offset>
        <OffsetUnit>minute</OffsetUnit>
        <UnitCost>$0.05</UnitCost>
      </Offset>
    </ActivitySubType>
  </ActivityType>
  <ActivityLocation>
    <Location>
      <LocationID>LID1</LocationID>
      <LocationName>New York City</LocationName>
      <Beneficiaries>
        <Beneficiary>
          <BeneficiaryID>BID1</BeneficiaryID>
          <BeneficiaryAmount>10%<BeneficiaryAmount>
        </Beneficiary>
        <Beneficiary>
          <BeneficiaryID>BID2</BeneficiaryID>
          <BeneficiaryAmount>20%<BeneficiaryAmount>
        </Beneficiary>
      </Beneficiaries>
    </Location>
    <Location>
      <LocationID>LID2</LocationID>
      <LocationName>San Francisco</LocationName>
      ...
    </Location>
  </ActivityLocation>
</Activity>
</XML>
```

The Activity data structure may be stored in the Activity database table 1419b. An activity may have an ActivityID that uniquely identifies the activity. The Activity data structure may store a variety of information regarding an activity in the ActivityType field. Such information may include an ActivityTypeName and/or an ActivitySubTypeName and these names may be used to display activity types and/or subtypes in the EcoAd application. Different activity subtypes may have different offset units and/or different unit costs. For example, a cab ride in an old gas car may cost $0.20 per minute in carbon impact, while a cab ride in a new hybrid car may cost only $0.05 per minute in carbon offset impact. In yet another example, cooking in a gas stove at 400 degrees Fahrenheit may cost $0.10 per minute in carbon impact, while cooking in an electric stove at 400 degrees Fahrenheit may cost $0.08 per minute in carbon impact. Multiple offset units may be taken into account for determining carbon impact of an activity. For example, determining carbon impact of a cab ride may take into account both the amount of time spent in the cab (e.g., minutes) and the distance driven (e.g., miles). Different locations may have different unit costs associated with an activity subtype. For example, a cab ride in an old gas car may cost $0.20 per minute in carbon impact in San Francisco, but $0.22 per minute in carbon impact in New York City. Information regarding offset units and unit costs may be used to calculate the purchase offset amount. Since many environmental issues have local ties, consumers may feel more strongly about and may want to give their EcoCredits to an environmental project that is located where they live and/or where they are currently located and impacting the environment. Accordingly, location based information (e.g., regarding offset costs) may facilitate calculating the purchase offset amount associated with the consumer's preferred location. As such, all credits may not be created equal and/or cost the same; it may be the case that when a consumer wishes to buy credits from and/or benefitting a locality, the costs will vary from prevalent market rates for similar credits available on a credit exchange.

Furthermore, location based information may be used to educate the consumer regarding the environmental impact of the activity. For example, educational information may be provided (e.g., displayed on their mobile device, kiosk, etc.) to the consumer regarding the fuel efficiency of a car, what the consumer may do to improve the fuel efficiency, alternate modes of transportation the consumer may use, and/or the like. Different locations (e.g., identified by LocationIDs) may have different beneficiaries (e.g., default EcoCredit recipients) associated with an activity and/or different benefit amounts may be allocated to different beneficiaries. For example, in the above example Activity XML structure, in New York City, beneficiary BID1 may receive 10% of the EcoCredits associated with the consumer watching an EcoAd, and beneficiary BID2 may receive 20% of the EcoCredits, and in San Francisco, beneficiary BID1 may receive 15% of the EcoCredits and beneficiary BID2 may receive 15% of the EcoCredits. Benefits allocation information may be used to determine beneficiaries associated with the consumer watching an EcoAd.

In FIG. 7, information regarding activity type and/or subtype may be retrieved at 705. This information may be retrieved by examining a configuration file of the EcoAd kiosk (e.g., the configuration file of a kiosk in a taxi may indicate that the activity type is cab ride and activity subtype is old gas car) that may be substantially in the following form:

```
<XML>
  <ActivityTypeName>Cab Ride</ActivityTypeName>
  <ActivitySubTypeName>Old Gas Car</ActivitySubTypeName>
  <KioskLocation>New York City</KioskLocation>
</XML>
```

Information regarding the consumer's location may be selected at 710. In one implementation, location information may be selected by examining a configuration file of the EcoAd kiosk (e.g., the configuration file of a kiosk in a taxi may indicate that the taxi is operating in New York City). In another implementation, location information may be determined using a GPS device. Activity metrics to track may be determined at 715. Activity metrics to track may be determined by examining the Activity data structure (e.g., using an XML parser). For example, the activity metrics to track for a cab ride may include time of the ride and distance of the ride.

The KCUT component may track the determined activity metrics. A determination may be made at 720 whether there are more activity metrics to be tracked (e.g., based on the information in the Activity data structure). If there are more metrics to track, the offset unit for a metric (e.g., minutes) may be determined at 725. The offset unit for the metric may be determined by examining the Activity data structure (e.g., using an XML parser). Activity usage in offset units for the metric may be tracked at 730 (e.g., a timer may track the time elapsed since the beginning of the ride). If there are more metrics to track, the next metric may be tracked in a similar manner (e.g., the distance traveled since the beginning of a cab ride may be tracked in miles using an odometer). If the activity is not yet complete 740 (e.g., the cab ride did not end yet), the metrics may be tracked until the activity is complete. The activity carbon usage for tracked metrics in corresponding offset units (e.g., minutes and miles) may be returned and/or stored at 750.

FIG. 8 shows a logic flow diagram illustrating an application carbon usage tracking (ACUT) component in one embodiment of the ECO AD PLATFORM. For example, the ACUT component may be used to track carbon usage in an EcoAd application (e.g., cooking at home). In FIG. 8, information regarding activity type and/or subtype may be received at 805. For example, this information may be received from the consumer via the user interface of the EcoAd application (e.g., as illustrated in FIG. 3). Information regarding the consumer's location may be received at 810. In one implementation, location information may be received from the consumer via the user interface of the EcoAd application. In another implementation, location information may be received using a GPS of the consumer's mobile device. In one embodiment, activity metrics to track may be determined at 815. Activity metrics to track may be determined by examining the Activity data structure (e.g., using an XML parser). For example, the activity metrics to track for cooking may include cooking temperature and cooking time.

The ACUT component may track the determined activity metrics. A determination may be made at 820 whether there are more activity metrics to be tracked (e.g., based on the information in the Activity data structure). If there are more metrics to track, the offset unit for a metric (e.g., cooking temperature) may be determined at 825. The offset unit for the metric may be determined by examining the Activity data structure (e.g., using an XML parser). The consumer may be prompted for activity usage in offset units for the metric at 830. For example, the consumer may be prompted to enter the cooking temperature using the EcoAd application user interface. If the consumer does not provide activity usage for the metric 835 (e.g., the consumer forgot at what temperature the consumer cooked), a default value may be used for activity usage for the metric 840 (e.g., 400 degrees Fahrenheit). For example, the default value may be determined by examining the Activity data structure (e.g., using an XML parser). If there are more metrics to track, the next metric may be tracked in a similar manner (e.g., the consumer may be prompted to enter the cooking time). If there are no more metrics to track, the activity carbon usage for tracked metrics in corresponding offset units (e.g., temperature and minutes) may be returned and/or stored at 850.

FIG. 9 shows a logic flow diagram illustrating a purchase offset calculating (POC) component in one embodiment of the ECO AD PLATFORM. For example, the POC component may be used to calculate the total purchase offset amount associated with an activity performed by the consumer. In FIG. 9, information regarding activity type and/or subtype may be retrieved at 905. In one implementation, this information may be retrieved by examining a configuration file of an EcoAd kiosk. In another implementation, this information may be retrieved by examining activity information provided by the consumer using the user interface of an EcoAd application. Information regarding the consumer's location may be selected at 910. In one implementation, location information may be selected by examining a configuration file of the EcoAd kiosk. In another implementation, location information may be determined using a GPS device (e.g., of the EcoAd kiosk, of the consumer's mobile device, and/or the like). In one embodiment, activity metrics to count may be determined at 915. Activity metrics to count may be determined by examining the Activity data structure (e.g., using an XML parser). For example, the activity metrics to count for a cab ride may include time of the ride and distance of the ride.

The POC component may calculate the total purchase offset amount for the determined activity metrics. A determination may be made at 920 whether there are more activity metrics to be counted (e.g., based on the information in the Activity data structure). If there are more metrics to count, the offset unit for a metric (e.g., minutes) may be determined at 925. For example, the offset unit for the metric may be determined by examining the Activity data structure (e.g., using an XML parser). Activity carbon usage for the metric in offset units for the metric may be retrieved at 930. In one implementation, the activity carbon usage for the metric may be retrieved based on data stored by the KCUT component. In another implementation, the activity carbon usage for the metric may be retrieved based on data stored by the ACUT component. A per unit cost for the metric offset unit may be determined at 935. The per unit cost for the metric may be determined by examining the Activity data structure (e.g., using an XML parser). For example, the per unit cost of a cab ride in an old gas car may be $0.20 per minute. The purchase offset amount for the metric may be calculated at 940. For example, the activity carbon usage for the metric in offset units (e.g., length of cab ride in minutes) may be multiplied by the per unit cost (e.g., $0.20 per minute) to determine the purchase offset amount for the metric. The running total of the purchase offset amount for the activity may be calculated at 945. For example, the calculated purchase offset amount for the metric may be added to the running total of the purchase offset amount for the activity to perform this calculation. If there are more metrics to count, the next metric may be counted in a similar manner. If there are no more metrics to count, the total purchase offset amount for the activity may be returned and/or stored at 950.

FIG. 10 shows a logic flow diagram illustrating an advertisement retrieving (AR) component in one embodiment of the ECO AD PLATFORM. For example, the AR component may be used to retrieve EcoAds with viewer impression cost sufficient to cover purchase offset amount associated with an activity. The Advertisement data structure may be used to help determine which EcoAds to display to the consumer and may be in XML format substantially in the following form:

```
<XML>
<Advertisement>
  <AdvertisementID>AdID1</AdvertisementID>
  <AdvertisementType>TV</AdvertisementType>
  <ContentType>Sports Products</ContentType>
  <MediaLink>Link1</MediaLink>
  <ActivityList>AID1, AID2</ActivityList>
  <Contribution>
      <LocationID>LID1</LocationID>
      <Demographics><TargetAge>25-49</TargetAge></Demographics>
      <AdvertisementSubType>DEFAULT</AdvertisementSubType>
      <AdvertiserContributionAmount>$2</AdvertiserContributionAmount>
      <ContentTypePremiumAmount>+$0.40</ContentTypePremiumAmount>
      <ActivityTypePremium>
          <ActivityID>AID1</ActivityID>
          <PremiumAmount>+$0.50</PremiumAmount>
      </ActivityTypePremium>
      <ActivityTypePremium>
          <ActivityID>AID2</ActivityID>
          <PremiumAmount>−$0.25</PremiumAmount>
      </ActivityTypePremium>
  </Contribution>
  <Contribution>
      ...
      <AdvertisementSubType>TV_BARCODE</AdvertisementSubType>
      <AdvertiserContributionAmount>$3</AdvertiserContributionAmount>
  </Contribution>
</Advertisement>
<Advertisement>
  <AdvertisementID>AdID2</AdvertisementID>
  <AdvertisementType>Web</AdvertisementType>
  <ContentType>Food</ContentType>
  <MediaLink>Link1</MediaLink>
  <DeviceCapabilities>
      <ScreenOrientation>Horizontal</ScreenOrientation>
      <ScreenSize>7+ inches</ScreenSize>
      <ScreenResolution>1024×768</ScreenResolution>
      <AudioCapability>Yes</AudioCapability>
      <PhysicalKeyboard>Yes</PhysicalKeyboard>
      <CreditCardReader>No</CreditCardReader>
  </DeviceCapabilities>
  <Contribution>
      ...
      <AdvertisementSubType>WEB_CLICK</AdvertisementSubType>
      <AdvertiserContributionAmount>$2</AdvertiserContributionAmount>
  </Contribution>
  <Contribution>
      ...
      <AdvertisementSubType>WEB_COMPREHEND</AdvertisementSubType>
      <AdvertiserContributionAmount>$3</AdvertiserContributionAmount>
  </Contribution>
  <Contribution>
      ...
      <AdvertisementSubType>WEB_SELECT</AdvertisementSubType>
      <AdvertiserContributionAmount>$4</AdvertiserContributionAmount>
  </Contribution>
  <Contribution>
      ...
      <AdvertisementSubType>WEB_SELECT_COMPREHEND</AdvertisementSubType>
      <AdvertiserContributionAmount>$5</AdvertiserContributionAmount>
  </Contribution>
</Advertisement>
<Advertisement>
  ...
  <AdvertisementType>Print</AdvertisementType>
      ...
      <AdvertisementSubType>PRINT_BARCODE</AdvertisementSubType>
      <AdvertiserContributionAmount>$3</AdvertiserContributionAmount>
</Advertisement>
</XML>
```

The Advertisement data structure may be stored in the Advertisement database table 1419c. An EcoAd may have an AdvertisementID that uniquely identifies the EcoAd. The Advertisement data structure may have an AdvertisementType (e.g., TV, Web, Print, Radio, and/or the like) that may indicate a media outlet through which the EcoAd may be exhibited. The Advertisement data structure may have a ContentType that may describe the type of product being advertised (e.g., sports products, food, and/or the like). In one implementation, the ContentType of an EcoAd may be compared with consumer preferences in a Consumer data structure to provide the consumer with EcoAd content in which the consumer is interested. The Advertisement data structure may include a MediaLink to the EcoAd content (e.g., the location of the video file that contains the EcoAd). For example, if the EcoAd is selected for playback to the consumer, the EcoAd is played back from the location indicated by the MediaLink (e.g., the location of the EcoAd file on a local storage device such as “C:\EcoAds\EcoAd1.avi”). Alternatively, the actual data for the media object may be embedded in the MediaLink field. The AdvertiserContributionAmount that an advertiser may be willing to pay for having the consumer watch an EcoAd may vary based on the location of the consumer, demographic information associated with the consumer, confirmation that the consumer viewed the EcoAd, comprehension of the EcoAd by the consumer, explicit selection of the EcoAd by the consumer, content type of the EcoAd (e.g., an EcoAd regarding less environmentally friendly content such as taking a plane may pay a premium over an EcoAd regarding taking a bus to motivate the consumer to view the EcoAd), activity type performed by the consumer, and/or the like, and/or any combination of the above. The Advertisement data structure may have information regarding the AdvertiserContributionAmount associated with a LocationID and content/activity premiums associated with contribution amounts. For example, the advertiser may be willing to pay $2 to display an EcoAd at location LID1, and $3 to display the EcoAd at location LID2. The Advertisement data structure may have information regarding the target demographics for an EcoAd. For example, the advertiser may be willing to pay $2 to display the EcoAd to government employees working in the sanitation department. In one embodiment, the Advertisement data structure may have an AdvertisementSubType that may indicate the AdvertiserContributionAmount the advertiser may be willing to pay for various EcoAd formats. For example, the advertiser may be willing to pay $2 to display an EcoAd on TV (e.g., DEFAULT AdvertisementSubType). In another example, the advertiser may be willing to pay $3 to display an EcoAd on TV if the consumer takes a picture of the EcoAd barcode (e.g., using the EcoAd barcode application). In yet another example, the advertiser may be willing to pay $2 if the consumer watches a web based EcoAd and confirms watching the EcoAd (e.g., by clicking on a button in a kiosk). In yet another example, the advertiser may be willing to pay $3 if the consumer watches a web based EcoAd and comprehends the EcoAd (e.g., by correctly answering a question using an EcoAd application). In yet another example, the advertiser may be willing to pay $4 if the consumer explicitly selects a web based EcoAd (e.g., from one of the available EcoAds presented to the consumer). In yet another example, the advertiser may be willing to pay $5 if the consumer explicitly selects a web based EcoAd and comprehends the EcoAd. The Advertisement data structure may be adjusted to improve the effectiveness of EcoAds based on consumer feedback. For example, information regarding consumers' interactions with an EcoAd may be recorded, aggregated and analyzed to refine how an EcoAd is displayed (e.g., location where the EcoAd is most effective, button placement of EcoAd components, and/or the like). Furthermore, EcoAds may be adjusted by aggregating user interactions with different usage models (e.g., within a cab, at an airport, on a train, in front of a computer at home or at work, and/or the like) and customizing parameters (e.g., screen resolution, length, message, and/or the like) of the EcoAds to facilitate effectiveness of the EcoAds as well as to maximize the follow-on EcoCredits donations.

The Consumer data structure may store information regarding an EcoAd consumer, regarding the consumer's preferences, regarding other accounts associated with the consumer, and/or the like, and may be in XML format substantially in the following form:

```
<XML>
<Consumer>
  <ConsumerID>CID1</ConsumerID>
  <LoginName>User1</LoginName>
  <FullName>John Doe</FullName>
  <Address>123 Main St, New City, State 11111</Address>
  <Preferences>
      <AdContentType>Sports Products, Food</AdContentType>
      <Advertisers>AdvID1, AdvID3</Advertisers>
      <Beneficiaries>BID1, BID2</Beneficiaries>
  </Preferences>
  <Demographics>
      <Age>40</Age>
      <Gender>Male</Gender>
  </Demographics>
  <AdditionalProfiles>
      <Profile>
          <LinksTo>games.cbs.com</LinksTo>
          <UserID>UID1</UserID>
          <Password>Password1</Password>
      </Profile>
      <Profile>
          <LinksTo>facebook.com</LinksTo>
          <UserID>UID2</UserID>
          <Password>Password2</Password>
      </Profile>
  </AdditionalProfiles>
</Consumer>
<Consumer>
  <ConsumerID>CID2</ConsumerID>
  ...
  <Preferences>
      <AdContentType>Food, Cleaning Products</AdContentType>
      <Advertisers>AdvID2, AdvID3</Advertisers>
      <Beneficiaries>BID2, BID3</Beneficiaries>
  </Preferences>
  <Demographics>...</Demographics>
  <AdditionalProfiles>
      ...
  </AdditionalProfiles>
</Consumer>
</XML>
```

The Consumer data structure may be stored in the Consumer database table 1419d. The Consumer data structure may be used to help determine which EcoAds to display to the consumer. A consumer may have a ConsumerID that uniquely identifies the consumer. The Consumer data structure may have a LoginName that the consumer may use as the consumer's EcoID (e.g., to login to the consumer's ECO AD PLATFORM account). The Consumer data structure may have information regarding the consumer such as the consumer's full name, the consumer's address, demographic information regarding the consumer (e.g., age, gender, place of employment, job title, location, and/or the like), and/or the like. Information regarding the consumer may be compared with target demographic information of an EcoAd (e.g., stored in the Advertisement data structure) and/or with target demographic information of an EcoAd Campaign (e.g., stored in the Advertiser data structure) to help determine which EcoAds to present to the consumer. The Consumer data structure may have information regarding the consumer's AdContentType preferences. For example, consumer CID1 may prefer to watch EcoAds regarding Sports Products and Food. In another example, consumer CID2 may prefer to watch EcoAds regarding Food and Cleaning Products. The consumer's AdContentType preferences may be compared with the ContentType associated with an EcoAd to help determine suitable EcoAds to present to the consumer. The Consumer data structure may have information regarding the consumer's advertisers preferences. For example, consumer CID1 may prefer to view EcoAds from advertisers AdvID1 and AdvID3. In another example, consumer CID2 may prefer to view EcoAds from advertisers AdvID2 and AdvID3. The consumer's advertisers preferences may be compared with the AdvertiserID of an advertiser to help determine suitable EcoAds to present to the consumer. Furthermore, the consumer may be associated with one or more consumer types (e.g., a student, a software developer, a mother, a father, and/or the like) and the profile information associated with consumer types may help provide more effective linking between EcoAds and the consumer, which may further increase the tie between the consumer and the EcoAd. For example, the consumer may be presented with EcoAds that support an EcoProject that the consumer cares about. The Consumer data structure may have information regarding the consumer's beneficiaries preferences (see FIG. 11 for more details regarding the Beneficiary data structure). For example, consumer CID1 may prefer that the EcoCredits earned by the consumer are given to beneficiaries BID1 and BID2. In another example, consumer CID2 may prefer that the EcoCredits earned by the consumer are given to beneficiaries BID2 and BIDS. The consumer's preferred beneficiaries may be presented (e.g., to select from a list) to the consumer (e.g., in a kiosk, in an EcoAd application, and/or the like) to facilitate selection of EcoCredit recipients. The consumer may link additional profiles to the consumer's ECO AD PLATFORM account. For example, the consumer may link a gaming account, a Facebook account, and/or the like. Information regarding the consumer associated with the linked accounts may be used to help determine which EcoAds to present to the consumer. Information regarding the consumer may be shared across the linked accounts (e.g., periodic messages may be posted on Facebook on the consumer's wall indicating how many EcoCredits the consumer earned this month).

The Advertiser data structure may be used to facilitate payment for displaying EcoAds by advertisers, to help determine which EcoAds to display to the consumer, and/or the like, and may be in XML format substantially in the following form:

```
<XML>
<Advertiser>
  <AdvertiserID>AdvID1</AdvertiserID>
  <AdvertiserName>AdvName1</AdvertiserName>
  <BankAccountNumber>13579</BankAccountNumber>
  <Campaigns>
      <Campaign>
          <CampaignID>CID1</CampaignID>
          <CampaignName>CampaignName1</CampaignName>
          <AdvertisementsList>AdID1, AdID2</AdvertisementsList>
          <Preferences>
              <TargetAge>25-49</TargetAge>
              <TargetGender>Female</TargetGender>
          </Preferences>
      </Campaign>
      <Campaign>
          <CampaignID>CID2</CampaignID>
          <CampaignName>CampaignName2</CampaignName>
          <AdvertisementsList>AdID3, AdID4</AdvertisementsList>
          <Preferences>
              <TargetAge>19-24</TargetAge>
              <TargetGender>Male</TargetGender>
          </Preferences>
      </Campaign>
  </Campaigns>
</Advertiser>
<Advertiser>
  <AdvertiserID>AdvID2</AdvertiserID>
  <AdvertiserName>AdvName2</AdvertiserName>
  <BankAccountNumber>24680</BankAccountNumber>
  <Campaigns>
      <Campaign>
          <CampaignID>CID4</CampaignID>
          <CampaignName>CampaignName4</CampaignName>
          <AdvertisementsList>AdID5, AdID6</AdvertisementsList>
          <Preferences>...</Preferences>
      </Campaign>
      ...
  </Campaigns>
</Advertiser>
</XML>
```

The Advertiser data structure may be stored in the Advertiser database table 1419e. An advertiser may have an AdvertiserID that uniquely identifies the advertiser. The Advertiser data structure may have a BankAccountNumber (e.g., a bank account, a credit card account, and/or the like) associated with the advertiser. The BankAccountNumber may be used to facilitate payment from the advertiser to the TV Network, the EcoFacilitator, and/or the like for displaying EcoAds (e.g., to bill the advertiser). The Advertiser data structure may have information regarding the advertiser's advertising Campaigns. Different advertising Campaigns may include different advertisements and/or may be targeted to different consumer demographics. For example, advertising Campaign CID1 may include advertisements AdID1 and AdID2, and may be targeted to female viewers ages 25 to 49. In another example, advertising Campaign CID2 may include advertisements AdID3 and AdID4, and may be targeted to male viewers ages 19 to 24. The advertiser's target demographic information may be compared with information regarding the consumer (e.g., information in the Consumer data structure) to help determine which EcoAds to present to the consumer.

In FIG. 10, a determination may be made at 1005 regarding EcoAds that are available for the activity. The ActivityLists of the Advertisement data structures associated with EcoAds may be compared to the ActivityID of the Activity data structure associated with the activity to make this determination. For example, EcoAd AdID1 may be available for activity AID1 (e.g., Cab Ride). A determination may be made at 1010 regarding EcoAds (e.g., EcoAds that are available for the activity) that are available for the consumer's location. The consumer's location (e.g., obtained using a configuration file of a kiosk) may be compared to the LocationIDs of the Advertisement data structures associated with EcoAds to make this determination. For example, EcoAd AdID1 may be available in New York City.

The advertisements with AdvertiserContributionAmount sufficient to cover purchase offset amount associated with the activity may be determined (e.g., from EcoAds that are available for the activity and for the location) at 1015. The purchase offset amount (e.g., calculated by the POC component) may be compared to the AdvertiserContributionAmounts of the Advertisement data structures associated with EcoAds to make this determination. For example, if the purchase offset amount is $3, a Web EcoAd with AdvertiserContributionAmount of $2 would not be acceptable, while a Web EcoAd with confirmation with AdvertiserContributionAmount of $3 would be acceptable. Multiple EcoAds may be considered during the determination. For example, a configuration file (e.g., of an EcoAd kiosk, of an EcoAd application, and/or the like) may indicate that up to two EcoAds may be shown to a consumer. Accordingly, combinations of EcoAds may be labeled as acceptable or not acceptable (e.g., based on the sum of the AdvertiserContributionAmounts for two ads as compared to the purchase offset amount).

A determination may be made at 1020 whether profile information for the consumer is available. For example, the consumer may be prompted to login to the consumer's ECO AD PLATFORM account at an EcoAd kiosk. In another example, the consumer may already be logged in via an EcoAd application on the consumer's mobile device. If the consumer profile information is not available, a determination may be made at 1025 whether a new consumer profile may be created. For example, an EcoAd kiosk without a keyboard may not be able to create new consumer profiles. In one implementation, a configuration file (e.g., associated with an EcoAd kiosk) may specify whether new consumer profiles may be created. In another implementation, the presence of a network connection may determine whether new consumer profiles may be created (e.g., an EcoAd application running on a mobile device may be able to create new consumer profiles when a wireless network connection is available, but not when a wireless network connection is not available). If new consumer profiles may be created, the consumer may be prompted to create a new consumer profile (e.g., via a user interface of the EcoAd application) at 1030. If the consumer decides to create a new profile, the ECO AD PLATFORM may also provide the consumer with an ability to unify the profile with other accounts (e.g., AdditionalProfiles) at 1035. Consumer profile information may be stored in a Consumer data structure. If a new consumer profile may not be created, or if the consumer declines to create a new profile, a default EcoAd (e.g., from the EcoAds with AdvertiserContributionAmount sufficient to cover purchase offset amount) may be selected for presentation to the consumer at 1070. In one implementation, a default EcoAd may be selected based on a default rank (e.g., default rank stored in an Advertisement data structure) associated with an EcoAd. For example, the EcoAd with the highest default rank may be selected for presentation to the consumer. In another implementation, a default EcoAd may be selected based on the number of times an EcoAd was shown. For example, the EcoAd that was shown the fewest times this month may be selected for presentation to the consumer.

If the consumer profile information is available, an EcoAd query may be generated based on the consumer's profile information at 1040. For example, the query may be constructed to select EcoAds (e.g., from the EcoAds with AdvertiserContributionAmount sufficient to cover purchase offset amount) that the consumer may be interested in viewing. The query may be based on comparing consumer profile information in the Consumer data structure (e.g., location, preferences, demographics, additional profiles, and/or the like) and information in the Advertisement data structure. Any fields in the Consumer data structure and/or Advertisement data structure may be used to match an EcoAd to the consumer. Furthermore, information regarding which EcoAds have the highest impact on various types of consumers (e.g., categorized based on location, preferences, demographics, additional profiles, and/or the like) may be analyzed and may be used to provide EcoAds that the consumer may be most interested in viewing. In situations where demographic information regarding a consumer may be unavailable, the consumer's coarse demographic information (e.g., height, gender, age, and/or the like) may be determined by using a biometric information analyzing device (e.g., a camera coupled with image processing software) to provide relevant EcoAds. For example, the query may be a SQL query substantially in the following form:

SELECT Advertisement.AdvertisementID
FROM Advertisement, Consumer
WHERE Advertisement.ContentType = Consumer.AdContentType

The query may be executed at 1045, and the matching EcoAds may be compared with advertiser campaign preferences (e.g., stored in the Advertiser data structure) at 1050 to select EcoAds that match advertiser campaign preferences (e.g., based on consumer demographic information). A determination may be made at 1055 whether matching EcoAds were found. If no matching EcoAds were found (e.g., EcoAds with AdvertiserContributionAmount sufficient to cover purchase offset amount that appeal to the consumer and match advertiser campaign preferences), a default EcoAd (e.g., from the EcoAds with AdvertiserContributionAmount sufficient to cover purchase offset amount) may be selected for presentation to the consumer at 1070. If matching EcoAds were found, the best matching advertisement may be selected at 1060. In one implementation, the best matching EcoAd may be selected based on a relevancy score (e.g., calculated based on the number of parameters that matched during the querying, the proximity of the EcoAd AdvertiserContributionAmount to the purchase offset amount, and/or the like). In another implementation, the best matching EcoAd may be selected based on the number of times a matching EcoAd was shown. For example, a matching EcoAd that was shown the fewest times this month may be selected for presentation to the consumer.

A determination may be made at 1075 whether the selected EcoAd is available from a local database. If the selected EcoAd is available from the local database, the EcoAd may be retrieved from the local database at 1080 (e.g., retrieved from a local hard drive, flash memory, and/or the like). If the selected EcoAd is not available from the local database, the EcoAd may be retrieved from a remote database at 1090 (e.g., retrieved from an ftp server over the network, streamed from a remote site, and/or the like). For example, retrieved EcoAd information may include information regarding an EcoProject of interest to the consumer and how much the advertiser has contributed to the EcoProject through the EcoAd. This information may be of interest to the consumer and may engage the consumer more strongly with the EcoAd.

FIG. 11 shows a logic flow diagram illustrating a transaction benefit apportionment (TBA) component in one embodiment of the ECO AD PLATFORM. In one embodiment, the TBA component may be used to distribute EcoCredits (e.g., earned by the consumer by watching EcoAds) among appropriate beneficiaries. The Beneficiary data structure may store information regarding beneficiaries and may be in XML format substantially in the following form:

```
<XML>
<Beneficiary>
  <BeneficiaryID>BID1</BeneficiaryID>
  <BeneficiaryName>New York City</BeneficiaryName>
  <Address>123 Main St, New York, NY 11112</Address>
  <EcoCreditAccountNumber>12345</EcoCreditAccountNumber>
  <EntityType>Government</EntityType>
</Beneficiary>
<Beneficiary>
  <BeneficiaryID>BID2</BeneficiaryID>
  <BeneficiaryName>Clean Waterways</BeneficiaryName>
  <Address>456 Main St, New York, NY 11112</Address>
  <EcoCreditAccountNumber>23456</EcoCreditAccountNumber>
  <EntityType>Non-profit</EntityType>
  <EcologyType>Waterways</EcologyType>
  <Industry>Waterways Cleanup</Industry>
</Beneficiary>
<Beneficiary>
  <BeneficiaryID>BID3</BeneficiaryID>
  <BeneficiaryName>Clean Energy</BeneficiaryName>
  <Address>567 Main St, New York, NY 11112</Address>
  <EcoCreditAccountNumber>34567</EcoCreditAccountNumber>
  <EntityType>Corporation</EntityType>
  <EcologyType>Solar</EcologyType>
  <Industry>Energy</Industry>
</Beneficiary>
</XML>
```

The Beneficiary data structure may be stored in the Beneficiary database table 1419f. A beneficiary may have a BeneficiaryID that uniquely identifies the beneficiary. The Beneficiary data structure may have an EcoCreditAccountNumber (e.g., a bank account, a deposit account number, and/or the like) associated with the beneficiary. The EcoCreditAccountNumber may be used to facilitate receiving EcoCredits allocated (e.g., by the consumer, by the EcoFacilitator, and/or the like) to the beneficiary (e.g., to credit the beneficiary's account with EcoCredits). The Beneficiary data structure may have information regarding the beneficiary such as the beneficiary's name, address, entity type, ecology type, industry, and/or the like. For example, the EcologyType may indicate whether the beneficiary is associated with solar, water, air, and/or the like ecology type. Information regarding beneficiaries may be presented to the consumer and/or used to assist the consumer in selecting the desired beneficiaries. For example, if the consumer wants to donate EcoCredits to a local solar energy producer, the ECO AD PLATFORM may compare the consumer's specified parameters (e.g., input via a user interface of the EcoAd application) to the Address, EcologyType and Industry fields of the Beneficiary data structure (e.g., using a SQL query) and present the consumer with a list of beneficiaries that may include the “Clean Energy” beneficiary BIDS.

In FIG. 11, the TBA component may await until a transaction involving EcoCredits is available at 1105 (e.g., await a notification). Information regarding the transaction may be retrieved at 1110. Transaction information may be retrieved from a transaction data structure describing the transaction and may be received along with the notification. For example, the transaction data structure may be in XML format substantially in the following form:

```
<XML>
      <Transaction>
          <TransactionID>TID1</TransactionID>
          <Location>LID1</Location>
          <Activity>AID1</Activity>
          <PurchaseOffsetAmount>$3</PurchaseOffsetAmount>
          <PaymentType>EcoAd</PaymentType>
          <Advertisement>AdID1</Advertisement>
          <Advertiser>AdvID1</Advertiser>
          <Consumer>CID1</Consumer>
          <ConsumerSelectedBeneficiary>
              <Beneficiary>BID3</Beneficiary>
              <BeneficiaryAmount>5%</BeneficiaryAmount>
          </ConsumerSelectedBeneficiary>
      </Transaction>
</XML>
```

The activity may be determined 1115 by examining (e.g., using an XML parser) the transaction data structure (e.g., the activity is AID1). The beneficiaries may be queried based on activity at 1120. In one implementation, the beneficiaries associated with an activity may be determined based on the information in the Activity data structure (e.g., using an XML parser). The beneficiaries associated with an activity may be determined based on the consumer selected beneficiaries in the transaction data structure (e.g., using an XML parser). A determination may be made at 1125 whether beneficiary results exist. If beneficiaries exist for the activity, a beneficiaries apportionment table (e.g., created based on BeneficiaryAmount information in the Activity data structure, in the transaction data structure, and/or the like) may be loaded for determined beneficiaries at 1130. If no beneficiary results exist, a default beneficiaries apportionment table (e.g., based on a configuration file) may be loaded at 1140.

A determination may be made at 1150 whether the transaction is a cash transaction (e.g., PaymentType is Cash, which may include cash payments, credit card payments, bank account payments, and/or the like), or an EcoAd viewing transaction (e.g., PaymentType is EcoAd). If the PaymentType is Cash, the cash value amount of the payment may be parsed at 1155 (e.g., from the transaction data structure). If the PaymentType is EcoAd, the transaction activity value of the payment may be queried at 1160. For example, the transaction activity value of the payment may be determined by examining the AdvertiserContributionAmount of the Advertisement data structure associated with the EcoAd.

A determination may be made at 1165 whether there are more beneficiaries that should receive payment for the transaction (e.g., based on the list of beneficiaries in the beneficiaries apportionment table). If there are more beneficiaries that should receive payment, the beneficiary's deposit account may be determined at 1170. The beneficiary's deposit account may be determined by examining the EcoCreditAccountNumber field of the Beneficiary data structure associated with the beneficiary. The beneficiary apportionment of payment value amount may be determined at 1175 (e.g., based on the values in the beneficiaries apportionment table). In one implementation, the values in the beneficiaries apportionment table may be percentages of payment that should be allocated to the beneficiaries. In another implementation, the values in the beneficiaries apportionment table may be dollar amounts that should be allocated to the beneficiaries. A determination may be made at 1180 whether sufficient payment has been received to provide the determined apportionment to the beneficiary, and an error notification may be generated at 1185 if sufficient payment has not been received. If sufficient payment has been received, the deposit of the determined apportionment may be effected at 1190 (e.g., the deposit account of the beneficiary may be credited). The deposit may be a wire transfer transmitted in XML format substantially in the following form:

```
<XML>
    <WireTransfer>
      <From>
        <EntityID>ID778</EntityID>
        <AccountNumber>846432</AccountNumber>
      </From>
      <To>
        <EntityID>ID987</EntityID>
        <BankName>Bank1</BankName>
        <BankAddress>address1</BankAddress>
        <BankRoutingNumber>444555666</BankRoutingNumber>
        <AccountNumber>666555444</AccountNumber>
      </To>
      <TransferAmount>$100</TransferAmount>
    </WireTransfer>
</XML>
```

If there are more beneficiaries that should receive payment for the transaction, the next beneficiary may be paid in a similar manner. If there are no more beneficiaries that should receive payment for the transaction, the TBA component may move on to the next available transaction.

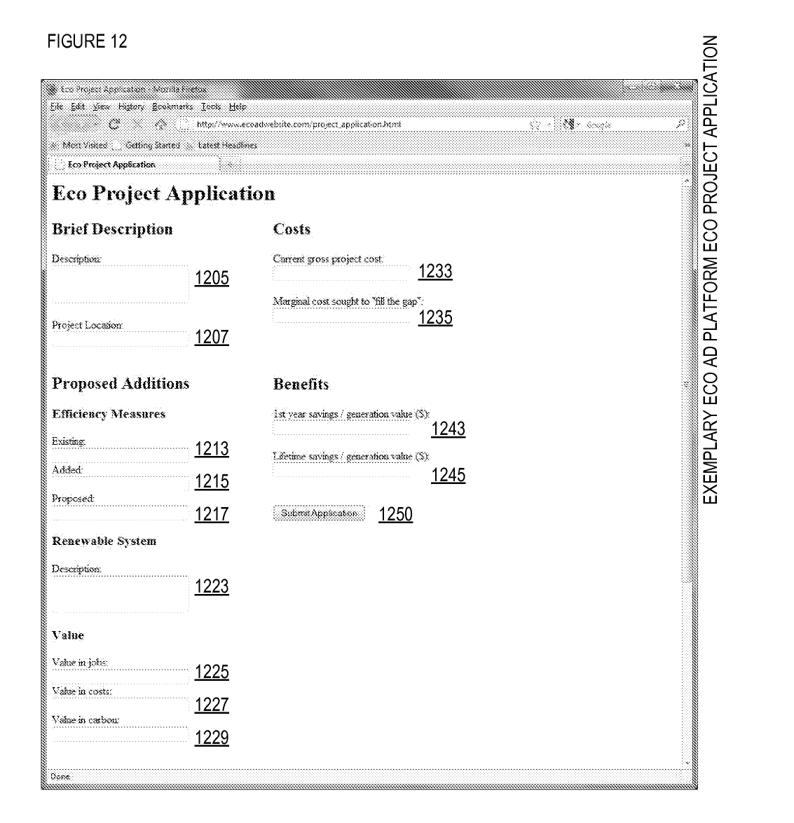

FIG. 12 shows a screen shot diagram illustrating an Eco Project Application in one embodiment of the ECO AD PLATFORM. Information in an application supplied by an applicant that would like to obtain funding for a project may be used to determine whether the project should be approved as a selected EcoProject. As illustrated in FIG. 12, the applicant may provide a Brief Description of the project. The Brief Description may include a description 1205 and a project location 1207. The applicant may describe Proposed Additions, which may include Efficiency Measures, Renewable System, Value, and/or the like. The Efficiency Measures may include existing 1213, added 1215 and proposed 1217 efficiency measures. The Renewable System may include a description of the renewable system 1223. The Value may include a value in jobs 1225, a value in costs 1227, and a value in carbon 1229. The applicant may provide Costs associated with the project. The Costs may include a current gross project cost 1233 and a margin cost sought to “fill the gap” 1235. The applicant may describe Benefits associated with the project. The Benefits may include 1st year saving/generation value 1243 and lifetime savings/generation value 1245.

The applicant may submit the application by clicking the Submit Application button 1250. The information submitted by the applicant may be stored in a ProjectApplication data structure and may be in XML format substantially in the following form:

```
<XML>
<ProjectApplication>
  <ProjectApplicationID>PAID1</ProjectApplicationID>
  <ProjectApplicationDate>November 1, 2011</ProjectApplicationDate>
  <BriefDescription>
    <Description>Project description</Description>
    <Location>Project location</Location>
  </BriefDescription>
  <ProposedAdditions>
    <EfficiencyMeasures>
      <Existing>existing</Existing>
      <Added>newly added</Added>
      <Proposed>proposed</Proposed>
    </EfficiencyMeasures>
    <RenewableSystem>
      <Description>renewable system description</Description>
    </RenewableSystem>
    <Value>
      <Jobs>100<Jobs>
      <Costs>$1,000</Costs>
      <Carbon>10,000 Carbon Credits</Carbon>
    </Value>
  </ProposedAdditions>
  <Costs>
    <Gross>$2,000,000</Gross>
    <Marginal>$200,000</Marginal>
  </Costs>
  <Benefits>
    <FirstYearToGenerationValue>10</FirstYearToGenerationValue>
    <LifetimeToGenerationValue>12</LifetimeToGenerationValue>
  </Benefits>
</ProjectApplication>
<ProjectApplication>
  ...
</ProjectApplication>
</XML>
```

The ProjectApplication data structure may be stored in the Project Application database table 1419g. The project application may have a ProjectApplicationID that uniquely identifies the project application.

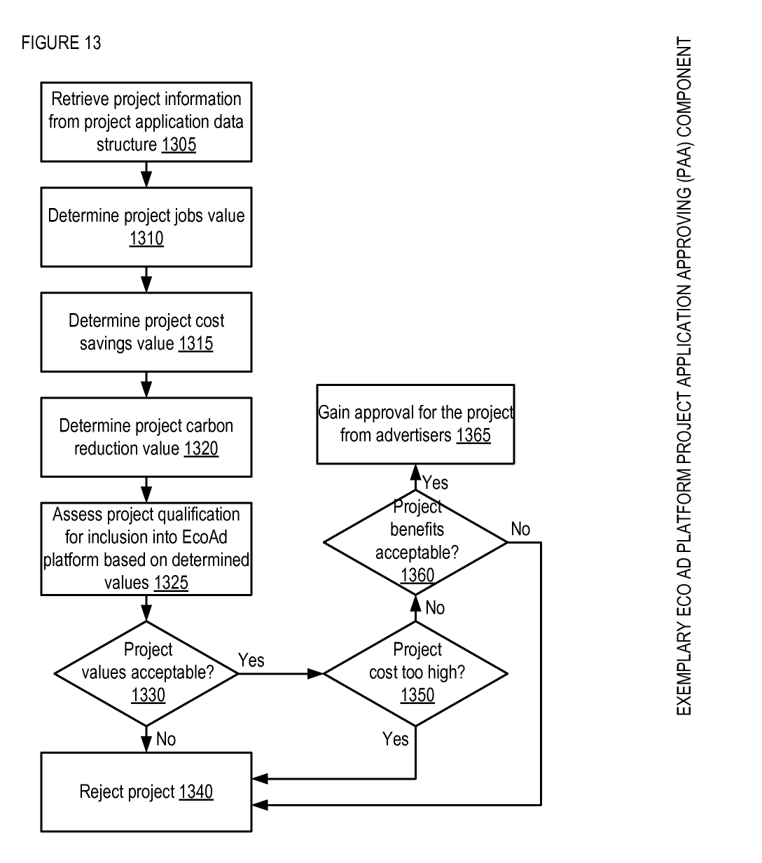

FIG. 13 shows a logic flow diagram illustrating a project application approving (PAA) component in one embodiment of the ECO AD PLATFORM. In FIG. 613, information regarding a project may be retrieved from the ProjectApplication data structure at 1305. The project jobs value may be determined at 1310. The Jobs field of the ProjectApplication data structure may be examined (e.g., using an XML parser) to make this determination. For example, the Jobs field of the ProjectApplication data structure may indicate that the project is expected to generate 100 jobs. The project cost saving value may be determined at 1315. The Costs field of the ProjectApplication data structure may be examined to make this determination. For example, the Costs field of the ProjectApplication data structure may indicate that the project is expected to generate $1,000 in savings (e.g., per month). The project carbon reduction value may be determined at 1320. The Carbon field of the ProjectApplication data structure may be examined to make this determination. For example, the Carbon field of the ProjectApplication data structure may indicate that the project is expected to generate 10,000 carbon credits (e.g., per year).

The project's qualification for inclusion into the ECO AD PLATFORM may be assessed based on the determined values at 1325. The project's values may be compared (e.g., using minimum values, maximum values, ranges, qualitative values, and/or the like) to specified parameters (e.g., specified by the EcoFacilitator and stored in a configuration file) to make this determination. For example, the EcoFacilitator may specify that projects that create at least 50 jobs, produce cost saving of at least $500, and generate at least 5,000 carbon credits may qualify for inclusion into the ECO AD PLATFORM (e.g., 10 times the benefit as compared to an advertiser's cost to fund the EcoAd and project). A determination may be made at 1330 whether the project's value are acceptable. If the values are not acceptable, the project may be rejected at 1340. For example, an error message may be generated (e.g., “sorry your project does not qualify”), and the applicant may be invited to adjust project parameters and to resubmit the project application. To aid applicants with submitting successful project applications, the ECO AD PLATFORM may aggregate and analyze information regarding project application submissions and provide applicants with feedback. The ECO AD PLATFORM may track approved and/or rejected project applications, information regarding submissions (e.g., project location, demographics, parameters, and/or the like), and/or the like, and analyze this data to determine which project applications are likely to be approved. For example, the ECO AD PLATFORM may generate reports with such analysis, create an index of successful locations, demographics, parameters, and/or the like, and provide this information (e.g., via a website) to the applicants. In another example, the ECO AD PLATFORM may detect that a project application contains a field value (e.g., total cost more than $1M) associated with high rejection rate and may inform the applicant that project applications with such field values are likely to be rejected. In another embodiment, these aggregated values may comprise a published index showing the most actively approved of areas, the projects creating the greatest positive impact, etc.

If the values are acceptable, project costs may be examined at 1350 to determine whether the project costs are too high. The Costs such as Gross (e.g., total cost), Marginal (e.g., EcoFacilitator's contribution), and/or the like fields of the ProjectApplication data structure may be examined and compared to predetermined cost limits (e.g., specified by the EcoFacilitator) to make this determination. For example, the EcoFacilitator may specify that the EcoFacilitator may invest a maximum of $500,000 into a project and/or project component. In another example, the EcoFacilitator may specify that the EcoFacilitator may contribute no more than 10% of a project's and/or a project component's total cost. If the project costs are too high, the project may be rejected at 1340.

If the project costs are not too high, project benefits may be examined at 1360. The Benefits such as FirstYearToGenerationValue (e.g., first year project benefits), LifetimeToGenerationValue (e.g., lifetime project benefits), and/or the like fields of the ProjectApplication data structure may be examined and compared to predetermined benefits restrictions (e.g., specified by the EcoFacilitator) to make this determination. For example, the EcoFacilitator may specify that the EcoFacilitator may invest in projects that produce benefits of (e.g., during the first year, during lifetime, and/or the like) a minimum of 10 to 1 (e.g., a dollar of investment generates at least 10 dollars in carbon credits). If the project benefits are not acceptable, the project may be rejected at 1340. If the project benefits are acceptable, the project may be sent for approval to the advertisers at 1365. Upon approval by advertisers, the applicant may become a beneficiary in the ECO AD PLATFORM.

### ECO AD PLATFORM Controller

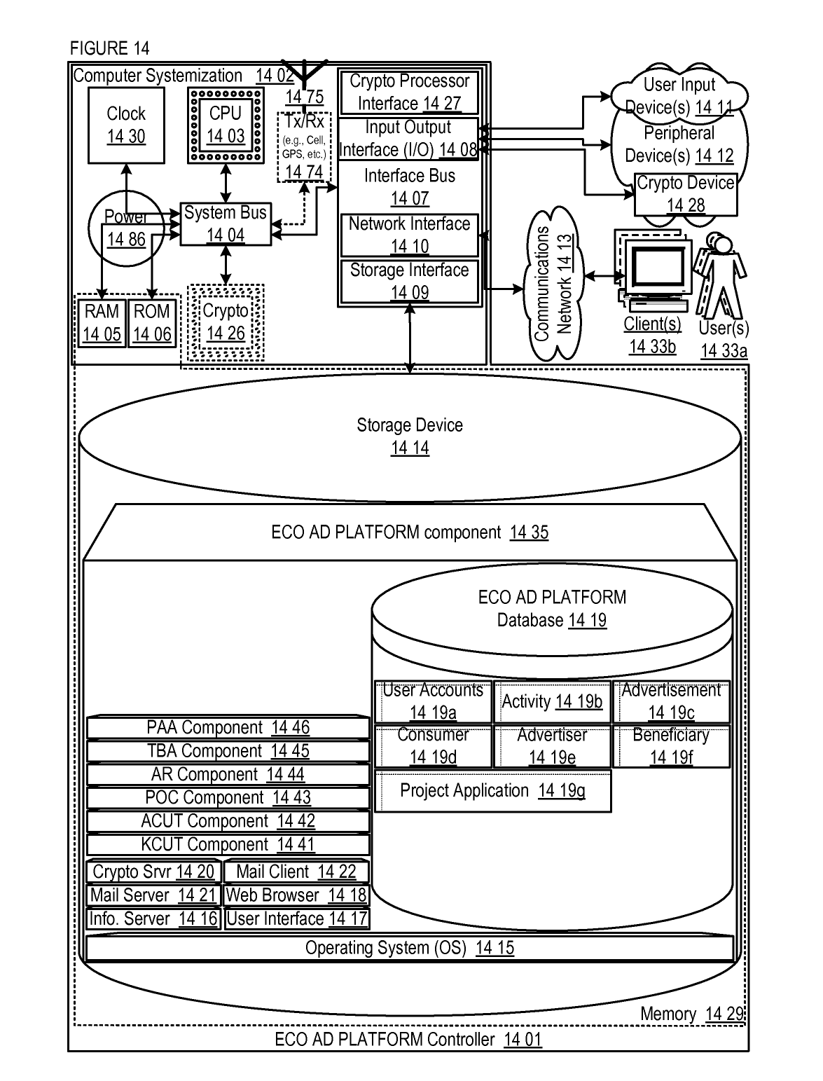

FIG. 14 shows a block diagram illustrating embodiments of a ECO AD PLATFORM controller. In this embodiment, the ECO AD PLATFORM controller 1401 may serve to aggregate, process, store, search, serve, identify, instruct, generate, match, and/or facilitate interactions with a computer through a variety of information technologies, and/or other related data.

Typically, users, which may be people and/or other systems, may engage information technology systems (e.g., computers) to facilitate information processing. In turn, computers employ processors to process information; such processors 1403 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1429 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the ECO AD PLATFORM controller 1401 may be connected to and/or communicate with entities such as, but not limited to: one or more users from user input devices 1411; peripheral devices 1412; an optional cryptographic processor device 1428; and/or a communications network 1413.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The ECO AD PLATFORM controller 1401 may be based on computer systems that may comprise, but are not limited to, components such as: a computer systemization 1402 connected to memory 1429.

### Computer Systemization

A computer systemization 1402 may comprise a clock 1430, central processing unit (“CPU(s)” and/or “processor(s)” (these terms are used interchangeable throughout the disclosure unless noted to the contrary)) 1403, a memory 1429 (e.g., a read only memory (ROM) 1406, a random access memory (RAM) 1405, etc.), and/or an interface bus 1407, and most frequently, although not necessarily, are all interconnected and/or communicating through a system bus 1404 on one or more (mother)board(s) 1402 having conductive and/or otherwise transportive circuit pathways through which instructions (e.g., binary encoded signals) may travel to effectuate communications, operations, storage, etc. The computer systemization may be connected to a power source 1486; e.g., optionally the power source may be internal. Optionally, a cryptographic processor 1426 and/or transceivers (e.g., ICs) 1474 may be connected to the system bus. In another embodiment, the cryptographic processor and/or transceivers may be connected as either internal and/or external peripheral devices 1412 via the interface bus I/O. In turn, the transceivers may be connected to antenna(s) 1475, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing ECO AD PLATFORM controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1429 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall; IBM's and Sony's Cell processor; Intel's Celeron, Core (2) Duo, Itanium, Pentium, Xeon; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the ECO AD PLATFORM controller and beyond through various interfaces. Should processing requirements dictate a greater amount speed and/or capacity, distributed processors (e.g., Distributed ECO AD PLATFORM), mainframe, multi-core, parallel, and/or super-computer architectures may similarly be employed. Alternatively, should deployment requirements dictate greater portability, smartphones may be employed.

Depending on the particular implementation, features of the ECO AD PLATFORM may be achieved by implementing a microcontroller such as CAST's R8051XC2 microcontroller; Intel's MCS 51 (i.e., 8051 microcontroller); and/or the like. Also, to implement certain features of the ECO AD PLATFORM, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the ECO AD PLATFORM component collection (distributed or otherwise) and/or features may be implemented via the microprocessor and/or via embedded components; e.g., via ASIC, coprocessor, DSP, FPGA, and/or the like. Alternately, some implementations of the ECO AD PLATFORM may be implemented with embedded components that are configured and used to achieve a variety of features or signal processing.

Depending on the particular implementation, the embedded components may include software solutions, hardware solutions, and/or some combination of both hardware/software solutions. For example, ECO AD PLATFORM features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the ECO AD PLATFORM features. A hierarchy of programmable interconnects allow logic blocks to be interconnected as needed by the ECO AD PLATFORM system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the ECO AD PLATFORM may be developed on regular FPGAs and then migrated into a fixed version that more resembles ASIC implementations. Alternate or coordinating implementations may migrate ECO AD PLATFORM controller features to a final ASIC instead of or in addition to FPGAs. Depending on the implementation all of the aforementioned embedded components and microprocessors may be considered the “CPU” and/or “processor” for the ECO AD PLATFORM.

### Power Source

The power source 1486 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1486 is connected to at least one of the interconnected subsequent components of the ECO AD PLATFORM thereby providing an electric current to all subsequent components. In one example, the power source 1486 is connected to the system bus component 1404. In an alternative embodiment, an outside power source 1486 is provided through a connection across the I/O 1408 interface. For example, a USB and/or IEEE 1394 connection carries both data and power across the connection and is therefore a suitable source of power.

### Interface Adapters

Interface bus(ses) 1407 may accept, connect, and/or communicate to a number of interface adapters, conventionally although not necessarily in the form of adapter cards, such as but not limited to: input output interfaces (I/O) 1408, storage interfaces 1409, network interfaces 1410, and/or the like. Optionally, cryptographic processor interfaces 1427 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1409 may accept, communicate, and/or connect to a number of storage devices such as, but not limited to: storage devices 1414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1410 may accept, communicate, and/or connect to a communications network 1413. Through a communications network 1413, the ECO AD PLATFORM controller is accessible through remote clients 1433b (e.g., computers with web browsers) by users 1433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed ECO AD PLATFORM), architectures may similarly be employed to pool, load balance, and/or otherwise increase the communicative bandwidth required by the ECO AD PLATFORM controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1410 may be used to engage with various communications network types 1413. For example, multiple network interfaces may be employed to allow for the communication over broadcast, multicast, and/or unicast networks.

Input Output interfaces (I/O) 1408 may accept, communicate, and/or connect to user input devices 1411, peripheral devices 1412, cryptographic processor devices 1428, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1411 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1412 may be connected and/or communicate to I/O and/or other facilities of the like such as network interfaces, storage interfaces, directly to the interface bus, system bus, the CPU, and/or the like. Peripheral devices may be external, internal and/or part of the ECO AD PLATFORM controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the ECO AD PLATFORM controller may be embodied as an embedded, dedicated, and/or monitor-less (i.e., headless) device, wherein access would be provided over a network interface connection.

Cryptographic units such as, but not limited to, microcontrollers, processors 1426, interfaces 1427, and/or devices 1428 may be attached, and/or communicate with the ECO AD PLATFORM controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1429. However, memory is a fungible technology and resource, thus, any number of memory embodiments may be employed in lieu of or in concert with one another. It is to be understood that the ECO AD PLATFORM controller and/or a computer systemization may employ various forms of memory 1429. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1429 will include ROM 1406, RAM 1405, and a storage device 1414. A storage device 1414 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1429 may contain a collection of program and/or database components and/or data such as, but not limited to: operating system component(s) 1415 (operating system); information server component(s) 1416 (information server); user interface component(s) 1417 (user interface); Web browser component(s) 1418 (Web browser); database(s) 1419; mail server component(s) 1421; mail client component(s) 1422; cryptographic server component(s) 1420 (cryptographic server); the ECO AD PLATFORM component(s) 1435; and/or the like (i.e., collectively a component collection). These components may be stored and accessed from the storage devices and/or from storage devices accessible through an interface bus. Although non-conventional program components such as those in the component collection, typically, are stored in a local storage device 1414, they may also be loaded and/or stored in memory such as: peripheral devices, RAM, remote storage facilities through a communications network, ROM, various forms of memory, and/or the like.

### Operating System

The operating system component 1415 is an executable program component facilitating the operation of the ECO AD PLATFORM controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS and iOS, Microsoft Windows Mobile/NT/Vista/XP (Server)/7, Palm WebOS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the ECO AD PLATFORM controller to communicate with other entities through a communications network 1413. Various communication protocols may be used by the ECO AD PLATFORM controller as a subcarrier transport mechanism for interaction, such as, but not limited to: multicast, TCP/IP, UDP, unicast, and/or the like.

### Information Server

An information server component 1416 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the ECO AD PLATFORM controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the ECO AD PLATFORM database 1419, operating systems, other program components, user interfaces, Web browsers, and/or the like.

Access to the ECO AD PLATFORM database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the ECO AD PLATFORM. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the ECO AD PLATFORM as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1417 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1418 is a stored program component that is executed by a CPU. The Web browser may be a conventional hypertext viewing application such as Microsoft Internet Explorer or Mozilla Firefox. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox's NPAPI, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the ECO AD PLATFORM enabled nodes. The combined application may be nugatory on systems employing standard Web browsers.

### Mail Server

A mail server component 1421 is a stored program component that is executed by a CPU 1403. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the ECO AD PLATFORM.

Access to the ECO AD PLATFORM mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1422 is a stored program component that is executed by a CPU 1403. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1420 is a stored program component that is executed by a CPU 1403, cryptographic processor 1426, cryptographic processor interface 1427, cryptographic processor device 1428, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the ECO AD PLATFORM may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the ECO AD PLATFORM component to engage in secure transactions if so desired. The cryptographic component facilitates the secure accessing of resources on the ECO AD PLATFORM and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The ECO AD PLATFORM Database

The ECO AD PLATFORM database component 1419 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the ECO AD PLATFORM database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the ECO AD PLATFORM database is implemented as a data-structure, the use of the ECO AD PLATFORM database 1419 may be integrated into another component such as the ECO AD PLATFORM component 1435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1419 includes several tables 1419a-g. A user table 1419a includes fields such as, but not limited to: user_ID, username, and/or the like. The user table may support and/or track multiple entity accounts on a ECO AD PLATFORM. An activity table 1419b includes fields such as, but not limited to: ActivityID, ActivityType, ActivitySubType, Offset, ActivityLocation, Beneficiaries, and/or the like. An advertisement table 1419c includes fields such as, but not limited to: AdvertisementID, AdvertisementType, ContentType, MediaLink, ActivityList, Contribution, and/or the like. A Consumer table 1419d includes fields such as, but not limited to: ConsumerID, ConsumerName, FullName, Address, Preferences, Demographics, AdditionalProfiles, and/or the like. An advertiser table 1419e includes fields such as, but not limited to: AdvertiserID, AdvertiserName, BankAccountNumber, Campaigns, and/or the like. A Beneficiary table 1419f includes fields such as, but not limited to: BeneficiaryID, BeneficiaryName, Address, EcoCreditAccountNumber, EntityType, EcologyType, Industry, and/or the like. A project application table 1419g includes fields such as, but not limited to: ProjectApplicationID, ProjectApplicationDate, BriefDescription, ProposedAdditions, Costs, Benefits, and/or the like.

In one embodiment, the ECO AD PLATFORM database may interact with other database systems. For example, employing a distributed database system, queries and data access by search ECO AD PLATFORM component may treat the combination of the ECO AD PLATFORM database, an integrated data security layer database as a single database entity.

In one embodiment, user programs may contain various user interface primitives, which may serve to update the ECO AD PLATFORM. Also, various accounts may require custom database tables depending upon the environments and the types of clients the ECO AD PLATFORM may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1419a-g. The ECO AD PLATFORM may be configured to keep track of various settings, inputs, and parameters via database controllers.

The ECO AD PLATFORM database may communicate to and/or with other components in a component collection, including itself, and/or facilities of the like. Most frequently, the ECO AD PLATFORM database communicates with the ECO AD PLATFORM component, other program components, and/or the like. The database may contain, retain, and provide information regarding other nodes and data.

### The ECO AD PLATFORMs

The ECO AD PLATFORM component 1435 is a stored program component that is executed by a CPU. In one embodiment, the ECO AD PLATFORM component incorporates any and/or all combinations of the aspects of the ECO AD PLATFORM that was discussed in the previous figures. As such, the ECO AD PLATFORM affects accessing, obtaining and the provision of information, services, transactions, and/or the like across various communications networks.

The ECO AD PLATFORM transforms carbon offset request, usage data, and gap financing inputs via ECO AD PLATFORM components KCUT, ACUT, POC, AR, TBA and, PAA into EcoCredits, jobs, and, savings outputs.

The ECO AD PLATFORM component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the ECO AD PLATFORM server employs a cryptographic server to encrypt and decrypt communications. The ECO AD PLATFORM component may communicate to and/or with other components in a component collection, including itself, and/or facilities of the like. Most frequently, the ECO AD PLATFORM component communicates with the ECO AD PLATFORM database, operating systems, other program components, and/or the like. The ECO AD PLATFORM may contain, communicate, generate, obtain, and/or provide program component, system, user, and/or data communications, requests, and/or responses.

### Distributed ECO AD PLATFORMs

The structure and/or operation of any of the ECO AD PLATFORM node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the ECO AD PLATFORM controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the ECO AD PLATFORM controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
      $input = “”;
      $input = socket_read($client, 1024);
      $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=
/com.ibm.IBMDI.doc/referenceguide295.htm

and other parser implementations:

http://publib.boulder.ibm.com/infocenter/tivihelp/v2r1/index.jsp?topic=
/com.ibm.IBMDI.doc/referenceguide259.htm

all of which are hereby expressly incorporated by reference.

Additional embodiments may include:

1. A processor-implemented method to transform a pollution offset request to an environmental credit, comprising:

obtaining via a processor a pollution offset request from a consumer for a specified environment-impacting activity;

discerning via the processor environment-impacting activity parameters associated with the environment-impacting activity;

calculating via the processor an environment impact purchase offset amount using the discerned environment-impacting activity parameters;

providing the calculated environment impact purchase offset amount to an offset paying target; and

obtaining an offset payment from the offset paying target.

2. The method of embodiment 1, wherein the obtaining an offset payment further comprises:

querying an advertisement database for matching advertisements using user-environment criteria,
wherein the user-environment criteria include: environment-impacting activity parameters, user preferences, and advertisement parameters; and

selecting at least one advertisement from user-environment criteria querying result advertisements;

providing the at least one selected advertisement to the consumer for display; and

obtaining the calculated environment impact purchase offset amount from the offset paying target associated with the selected advertisement.

3. The method of embodiment 2, wherein the offset paying target is any of: an advertiser, a TV Network, and an environmental facilitator.
4. The method of embodiment 2, wherein the user-environment criteria also include location.
5. The method of embodiment 2, wherein the user-environment criteria also include any of: viewer impression cost, advertisement content type, consumer demographics.
6. The method of embodiment 5, wherein the environment-impacting activity parameters include an intensity of the environment-impacting activity.
7. The method of embodiment 6, wherein the intensity is measured by any of: duration, length, distance, temperature.
8. The method of embodiment 2, wherein a value of a discerned environment-impacting activity parameter is a default value.
9. The method of embodiment 2, wherein a value of a discerned environment-impacting activity parameter is determined via a sensor.
10. The method of embodiment 2, wherein a value of a discerned environment-impacting activity parameter is provided by the consumer.
11. The method of embodiment 2, wherein the selecting further comprises:

providing user-environment criteria querying result advertisements to the consumer for selection; and

obtaining a consumer selection from the provided result advertisements.

12. The method of embodiment 11, wherein the obtaining a consumer selection further comprises:

specifying how many advertisements the consumer must select; and

obtaining a consumer selection of the specified number of advertisements.

13. The method of embodiment 2, wherein the selecting further comprises querying the advertisement database for matching advertisements with viewer impression cost sufficient to pay the calculated environment impact purchase offset amount.
14. The method of embodiment 2, wherein the providing the at least one selected advertisement further comprises:

obtaining confirmation that the consumer has interacted with the at least one selected advertisement.

15. The method of embodiment 14, wherein the confirmation is obtained by prompting the consumer at times specified by the advertiser.
16. The method of embodiment 14, wherein a viewer impression cost associated with the at least one selected advertisement depends on whether the consumer confirms that the consumer has interacted with the at least one selected advertisement.
17. The method of embodiment 14, further comprising:

aggregating statistics regarding how many consumers confirmed interacting with the at least one selected advertisement.

18. The method of embodiment 2, wherein the providing the at least one selected advertisement further comprises:

obtaining confirmation that the consumer comprehended the at least one selected advertisement.

19. The method of embodiment 18, wherein the confirmation is obtained by providing the consumer with a multiple choice question.
20. The method of embodiment 19, wherein a viewer impression cost associated with the at least one selected advertisement depends on whether the consumer answers the multiple choice question correctly.
21. The method of embodiment 18, further comprising:

aggregating statistics regarding how many consumers comprehended the at least one selected advertisement.

22. The method of embodiment 19, further comprising aggregating consumer response information associated with the multiple choice question.
23. The method of embodiment 2, further comprising:

providing environmentally related education information regarding the environment-impacting activity to the consumer.

24. The method of embodiment 1, wherein the obtaining an offset payment further comprises:

obtaining consumer payment information; and

obtaining the calculated environment impact purchase offset amount using the obtained consumer payment information.

25. The method of embodiment 24, wherein the obtaining payment information further comprises:

obtaining consumer identifying information from an identifying information carrying device; and

retrieving consumer payment information using the obtained consumer identifying information.

26. The method of embodiment 25, wherein the identifying information carrying device is a credit card.
27. The method of embodiment 25, wherein the identifying information carrying device is any of: an NFC capable phone, an RFID fob, a fingerprint scanner, a retinal scanner, a facial recognition scanner.
28. The method of embodiment 24, wherein the obtaining payment information further comprises:

obtaining consumer payment information from an identifying information carrying device.

29. The method of embodiment 28, wherein the identifying information carrying device is a credit card.
30. The method of embodiment 28, wherein the identifying information carrying device is any of: an NFC capable phone, an RFID fob.
31. The method of embodiment 1, further comprising using a portion of the obtained offset payment to provide an environmental credit to a beneficiary.
32. The method of embodiment 31, wherein the providing an environmental credit to a beneficiary further comprises:

obtaining a selection of a beneficiary; and

providing an environmental credit to the selected beneficiary.

33. The method of embodiment 32, wherein the beneficiary is selected by the consumer.
34. The method of embodiment 33, wherein the obtaining a selection of a beneficiary further comprises:

providing a beneficiaries list to the consumer; and

obtaining a selection of a beneficiary from the provided beneficiaries list.

35. The method of embodiment 34, further comprising obtaining an environmental credit amount to provide to the selected beneficiary.
36. The method of embodiment 35, wherein the environmental credit amount is a percentage value.
37. The method of embodiment 35, wherein the environmental credit amount is a numerical value.
38. The method of embodiment 34, wherein the beneficiaries list is a preferred beneficiaries list of the consumer.
39. The method of embodiment 32, wherein the obtaining a selection of a beneficiary further comprises:

selecting a beneficiary from a default beneficiaries list.

40. The method of embodiment 31, wherein the beneficiary is any of: an advertising channel, an advertiser, a governmental agency, a charity, an investor, the consumer, an environmental facilitator, an environmental project organizer.
41. The method of embodiment 31, further comprising:

providing environmental scorecard information regarding an amount of environmental credits that the consumer generated for the beneficiary.

42. The method of embodiment 41, further comprising:

providing an environmental scorecard comparison of the amount of environmental credits that the consumer generated for the beneficiary to an amount of environmental credits generated for the beneficiary by others in the consumer's social network.

43. The method of embodiment 31, further comprising:

providing environmental scorecard information regarding an amount of environmental credits that the consumer donated to the beneficiary.

44. The method of embodiment 43, further comprising:

providing an environmental scorecard comparison of the amount of environmental credits that the consumer donated to the beneficiary to an amount of environmental credits donated to the beneficiary by others in the consumer's social network.

45. A processor-implemented method to generate environmental credits, comprising:

providing via a processor an advertisement associated with an advertiser for display to consumers;

obtaining revenue from the advertiser based on displaying the advertisement to the consumers;

providing part of the obtained revenue to an environmental facilitator; and

obtaining beneficiary environmental credits generated by an environmental project funded by the environmental facilitator.

46. The method of embodiment 45, further comprising distributing at least a part of the obtained beneficiary environmental credits to other beneficiaries.
47. The method of embodiment 45, wherein the providing an advertisement further comprises certifying the advertisement.
48. The method of embodiment 47, wherein the certification further comprises associating a branded mark overlay with the advertisement.
49. The method of embodiment 47, wherein the certification further comprises cryptographically certifying the advertisement.
50. The method of embodiment 45, wherein the amount of the obtained environmental credits is a fixed default amount.
51. The method of embodiment 45, wherein the amount of the obtained environmental credits is a consumer selected amount.
52. The method of embodiment 45, wherein the amount of the obtained environmental credits is a negotiated amount.
53. A processor-implemented method to generate environmental credits, comprising:

providing via a processor an advertisement for display to consumers to an advertising channel;

providing payment for distributing the advertisement through the advertising channel for funding an environmental project; and

obtaining beneficiary environmental credits generated by the funded environmental project funded by an environmental facilitator.

54. The method of embodiment 53, further comprising distributing at least a part of the obtained beneficiary environmental credits to other beneficiaries.
55. The method of embodiment 53, wherein the provided advertisement is certified by the advertising channel.
56. The method of embodiment 53, wherein the payment is provided to the advertising channel and the advertising channel allocates part of the payment to an environmental facilitator.
57. The method of embodiment 53, wherein the payment is provided to an environmental facilitator and the environmental facilitator allocates part of the payment to the advertising channel.
58. The method of embodiment 53, wherein the payment is apportioned between and provided to the advertising channel and an environmental facilitator.
59. The method of embodiment 53, wherein the amount of the obtained environmental credits is a fixed default amount.
60. The method of embodiment 53, wherein the amount of the obtained environmental credits is a consumer selected amount.
61. The method of embodiment 53, wherein the amount of the obtained environmental credits is a negotiated amount.
62. A processor-implemented method to generate environmental credits, comprising:

providing via a processor a project application to an environmental facilitator;

obtaining via the processor approval for the project from the environmental facilitator;

obtaining funding from the environmental facilitator for the approved project from environmental advertising revenue provided by an advertiser;

providing measured and verified environmental information for an environmental credits request for the approved project for submission to an environmental credits issuer;

obtaining beneficiary environmental credits from the environmental credits issuer.

63. The method of embodiment 62, further comprising distributing at least a part of the obtained beneficiary environmental credits to other beneficiaries.
64. The method of embodiment 62, wherein the environmental credits are obtained directly from the environmental credits issuer.
65. The method of embodiment 62, wherein the environmental credits are obtained through the environmental facilitator.
66. The method of embodiment 62, further comprising:

providing at least a portion of the obtained environmental credits to the environmental facilitator.

67. A system to transform a pollution offset request to an environmental credit, comprising means to:

means to obtain a pollution offset request from a consumer for a specified environment-impacting activity;

means to discern environment-impacting activity parameters associated with the environment-impacting activity;

means to calculate an environment impact purchase offset amount using the discerned environment-impacting activity parameters;

means to provide the calculated environment impact purchase offset amount to an offset paying target; and

means to obtain an offset payment from the offset paying target.

68. A system to generate environmental credits, comprising means to:

means to provide an advertisement associated with an advertiser for display to consumers;

means to obtain revenue from the advertiser based on displaying the advertisement to the consumers;

means to provide part of the obtained revenue to an environmental facilitator; and

means to obtain beneficiary environmental credits generated by an environmental project funded by the environmental facilitator.

69. A system to generate environmental credits, comprising means to:

means to provide an advertisement for display to consumers to an advertising channel;

means to provide payment for distributing the advertisement through the advertising channel for funding an environmental project; and

means to obtain beneficiary environmental credits generated by the funded environmental project funded by an environmental facilitator.

70. A system to generate environmental credits, comprising means to:

means to provide a project application to an environmental facilitator;

means to obtain approval for the project from the environmental facilitator;

means to obtain funding from the environmental facilitator for the approved project from environmental advertising revenue provided by an advertiser;

means to provide measured and verified environmental information for an environmental credits request for the approved project for submission to an environmental credits issuer;

means to obtain beneficiary environmental credits from the environmental credits issuer.

71. An apparatus to transform a pollution offset request to an environmental credit, comprising:

a memory;

a processor disposed in communication with said memory, and configured to issue a plurality of processing instructions stored in the memory, wherein the processor issues instructions to:
obtain a pollution offset request from a consumer for a specified environment-impacting activity;
discern environment-impacting activity parameters associated with the environment-impacting activity;
calculate an environment impact purchase offset amount using the discerned environment-impacting activity parameters;
provide the calculated environment impact purchase offset amount to an offset paying target; and
obtain an offset payment from the offset paying target.
   72. An apparatus to generate environmental credits, comprising:

a memory;

a processor disposed in communication with said memory, and configured to issue a plurality of processing instructions stored in the memory, wherein the processor issues instructions to:
provide an advertisement associated with an advertiser for display to consumers;
obtain revenue from the advertiser based on displaying the advertisement to the consumers;
provide part of the obtained revenue to an environmental facilitator; and
obtain beneficiary environmental credits generated by an environmental project funded by the environmental facilitator.
   73. An apparatus to generate environmental credits, comprising:

a memory;

a processor disposed in communication with said memory, and configured to issue a plurality of processing instructions stored in the memory, wherein the processor issues instructions to:
provide an advertisement for display to consumers to an advertising channel;
provide payment for distributing the advertisement through the advertising channel for funding an environmental project; and
obtain beneficiary environmental credits generated by the funded environmental project funded by an environmental facilitator.
   74. An apparatus to generate environmental credits, comprising:

a memory;

a processor disposed in communication with said memory, and configured to issue a plurality of processing instructions stored in the memory, wherein the processor issues instructions to:
provide a project application to an environmental facilitator;
obtain approval for the project from the environmental facilitator;
obtain funding from the environmental facilitator for the approved project from environmental advertising revenue provided by an advertiser;
provide measured and verified environmental information for an environmental credits request for the approved project for submission to an environmental credits issuer;
obtain beneficiary environmental credits from the environmental credits issuer.
   75. An a pollution offset request to an environmental credit transforming processor-readable physical medium storing processor-issuable-and-generated instructions to:

obtain a pollution offset request from a consumer for a specified environment-impacting activity;

discern environment-impacting activity parameters associated with the environment-impacting activity;

calculate an environment impact purchase offset amount using the discerned environment-impacting activity parameters;

provide the calculated environment impact purchase offset amount to an offset paying target; and

obtain an offset payment from the offset paying target.

76. An environmental credits generating processor-readable physical medium storing processor-issuable-and-generated instructions to:

provide an advertisement associated with an advertiser for display to consumers;

obtain revenue from the advertiser based on displaying the advertisement to the consumers;

provide part of the obtained revenue to an environmental facilitator; and

obtain beneficiary environmental credits generated by an environmental project funded by the environmental facilitator.

77. An environmental credits generating processor-readable physical medium storing processor-issuable-and-generated instructions to:

provide an advertisement for display to consumers to an advertising channel;

provide payment for distributing the advertisement through the advertising channel for funding an environmental project; and

obtain beneficiary environmental credits generated by the funded environmental project funded by an environmental facilitator.

78. An environmental credits generating processor-readable physical medium storing processor-issuable-and-generated instructions to:

provide a project application to an environmental facilitator;

obtain approval for the project from the environmental facilitator;

obtain funding from the environmental facilitator for the approved project from environmental advertising revenue provided by an advertiser;

provide measured and verified environmental information for an environmental credits request for the approved project for submission to an environmental credits issuer;

obtain beneficiary environmental credits from the environmental credits issuer.

In order to address various issues and advance the art, the entirety of this application for APPARATUSES, METHODS AND SYSTEMS FOR AN ENVIRONMENTAL ADVERTISING, FINANCING AND MANAGEMENT PLATFORM (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a ECO AD PLATFORM individual and/or enterprise user, database configuration and/or relational model, data type, data transmission and/or network framework, syntax structure, and/or the like, various embodiments of the ECO AD PLATFORM, may be implemented that enable a great deal of flexibility and customization. For example, aspects of the ECO AD PLATFORM may be adapted for dealing with non-carbon pollutants such as sulfur dioxide, nitrogen oxides, and/or the like. While various embodiments and discussions of the ECO AD PLATFORM have been directed to funding environmental projects, however, it is to be understood that the embodiments described herein may be readily configured and/or customized for a wide variety of other applications and/or implementations.

What is claimed is:

1. A processor-implemented method to transform a pollution offset request to an environmental credit, comprising:
obtaining via a processor a pollution offset request from a consumer for a specified environment-impacting activity;
discerning via the processor environment-impacting activity parameters associated with the environment-impacting activity;
calculating via the processor an environment impact purchase offset amount using the discerned environment-impacting activity parameters;
providing the calculated environment impact purchase offset amount to an offset paying target; and
obtaining an offset payment from the offset paying target.

2. The method of claim 1, wherein the obtaining an offset payment further comprises:
querying an advertisement database for matching advertisements using user-environment criteria,
wherein the user-environment criteria include: environment-impacting activity parameters, user preferences, and advertisement parameters; and
selecting at least one advertisement from user-environment criteria querying result advertisements;
providing the at least one selected advertisement to the consumer for display; and
obtaining the calculated environment impact purchase offset amount from the offset paying target associated with the selected advertisement.

3. The method of claim 2, wherein the offset paying target is any of: an advertiser, a TV Network, and an environmental facilitator.

4. The method of claim 2, wherein the user-environment criteria also include location.

5. The method of claim 2, wherein the user-environment criteria also include any of: viewer impression cost, advertisement content type, consumer demographics.

6. The method of claim 5, wherein the environment-impacting activity parameters include an intensity of the environment-impacting activity.

7. The method of claim 6, wherein the intensity is measured by any of: duration, length, distance, temperature.

8. The method of claim 2, wherein a value of a discerned environment-impacting activity parameter is a default value.

9. The method of claim 2, wherein a value of a discerned environment-impacting activity parameter is determined via a sensor.

10. The method of claim 2, wherein a value of a discerned environment-impacting activity parameter is provided by the consumer.

11. The method of claim 2, wherein the selecting further comprises:
providing user-environment criteria querying result advertisements to the consumer for selection; and
obtaining a consumer selection from the provided result advertisements.

12. The method of claim 11, wherein the obtaining a consumer selection further comprises:
specifying how many advertisements the consumer must select; and
obtaining a consumer selection of the specified number of advertisements.

13. The method of claim 2, wherein the selecting further comprises querying the advertisement database for matching advertisements with viewer impression cost sufficient to pay the calculated environment impact purchase offset amount.

14. The method of claim 2, wherein the providing the at least one selected advertisement further comprises:
obtaining confirmation that the consumer has interacted with the at least one selected advertisement.

15. The method of claim 14, wherein the confirmation is obtained by prompting the consumer at times specified by the advertiser.

16. The method of claim 14, wherein a viewer impression cost associated with the at least one selected advertisement depends on whether the consumer confirms that the consumer has interacted with the at least one selected advertisement.

17. The method of claim 14, further comprising:
aggregating statistics regarding how many consumers confirmed interacting with the at least one selected advertisement.

18. The method of claim 2, wherein the providing the at least one selected advertisement further comprises:
obtaining confirmation that the consumer comprehended the at least one selected advertisement.

19. The method of claim 18, wherein the confirmation is obtained by providing the consumer with a multiple choice question.

20. The method of claim 19, wherein a viewer impression cost associated with the at least one selected advertisement depends on whether the consumer answers the multiple choice question correctly.
